(19) United States
(12) Patent Application Publication
(10) Pub. No.: US 2004/0001734 A1
(43) Pub. Date: Jan. 1, 2004

(54) Virtual keyboard and control means

(76) Inventor: James W. Burrell IV, Union, NJ (US)

Correspondence Address: LAW OFFICES, EZRA SUTTON, P. A., A PROFESSIONAL CORPORATION, PLAZA 9, 900 ROUTE 9, WOODBRIDGE, NJ, 07095, US

(21) Appl. No.: 10/071,952

(22) Filed: Feb. 7, 2002

(51) Int. Cl. B41J 5/14

(52) U.S. Cl. 400/472

(57) ABSTRACT

An eight bit binary code, read from left to right, used as a system and method for multi-lingual communication on eight sensors, as an eight dot braille arrangement or as a method of finger braille communication for deaf-blind individuals. Vowels are produced on a first set of four sensors combined with an unused second set of four sensors. Consonants are produced on a second set of four sensors combined with the consonant's preceding binary vowel chord produced on the first set of four sensors. The right thumb sensor produces a space when used independently, or a shift function when used simultaneously with a vowel or consonant chord. Punctuation is produced on a second set of four sensors combined with an unused first set of four sensors. Numbers are produced on a first set of four sensors combined with a second set of four activated sensors. The eight bit binary code produces alphabet scripts, fonts, punctuation, math functions, containment chords, cursor movement chords, symbols, monetary symbols, functions, graphics, etc. The invention also allows two sensor movement for robots and machines, two sensor movement in a virtual reality environment, and two sensor editing modes for a data processor.

### FIELD OF THE INVENTION

This invention relates to a data entry method on split space bar keyboards and an eight bit binary computer data code used as an eight dot braille arrangement, method of finger braille communication for the blind, deaf-blind, visually impaired, cerebral palsy, speech impaired, etc. and a method of producing a space, letters, numbers, data, symbols, characters, control, fonts, graphics, etc. on an eight sensor chordic data entry device or a split space bar keyboard.

### BACKGROUND OF THE INVENTION

This patent application is an improvement on the invention found in U.S. Pat. No. 5,993,089, in which a copyright and a patent was granted.

### DESCRIPTION OF PRIOR ART

There are numerous well-known, prior art keyboards along with systems and methods for inputting data into typewriters, braille writers, word processors, phones, computers, laptops, keyboards, touch screen input devices, PDAs, cell phones, virtual keyboards and the like. Unfortunately, most modern systems are inherently slow, difficult to learn, not organized in a logical fashion and/or cumbersome for the general population, including the handicapped, visually impaired, speech impaired, motion disabled and the like. The most used prior art keyboard is the QWERTY keyboard which derives its name from the first six letters on the top row of the alphabet keys or sensors. The data entry touch typing method, invented by the blind, is the method taught to use the QWERTY keyboard. The QWERTY keyboard and QWERTY touch typing method has been around longer than any other keyboard, excluding the piano, and was originally designed to slow down typists so that manual typewriter keys would not jam. A good explanation of the history of the QWERTY keyboard is set forth in an article entitled “TYPING WITH A TWO-HAND CHORD KEYBOARD: WILL THE QWERTY BECOME OBSOLETE” by Daniel Gopher and David Raij, IEEE Transactions on Systems, Man, and Cybernetics, Volume 18, No. 4, July-August 1988, pages 601-609.

In response to the relatively slow and cumbersome QWERTY system, some new word processors and computers have moved to the improved Dvorak layout, although very few. One of the characteristics of the Dvorak keyboard is that the vowels a, o, e, u and i form the first five keys of the second alphabetic row of the keyboard. The United States Department of the Navy tested the Dvorak design and found it to produce up to a twenty percent increase in typing speeds. While improved efficiencies are possible and proven with the Dvorak keyboard, it still does have some drawbacks, the major one of which is that the keys are not laid out in an ergonomic fashion to follow the natural ergonomic positions of the hands and fingers. Moreover, because there are more keys than the operator has digits, it is necessary for the operator to continually move his or her hands and fingers up and down or left and right to find and depress the appropriate key or keys. This tends to reduce the overall speed of the typist.

In order to increase speed, the chordic keyboard was invented. There are a number of chordic keyboards on the market, some of which have sets of linear rows, some have curved rows, some have vertical rows or some have horizontal rows. The common denominator is that it has fewer keys than the common QWERTY keyboard or the Dvorak keyboard, and that chords are employed, i.e. combinations of keys or sensors, to enter or produce specific letters, numbers, symbols, characters or functions. The fastest data entry keyboard presently used is the court stenographer's phonetic chord keyboard. There are other keyboards and devices available for attachment to personal computers and the like, in order to provide additional functions or to increase the speed of data entry.

The patent literature describes a number of efforts to improve the speed and efficiency of data entry on keyboards. For example, U.S. Pat. No. 4,680,572 to Meguire, et al. entitled CHORD ENTRY KEYING OF DATA FIELDS describes a keyboard arrangement, which in one embodiment, has eleven keys arranged in two sets of five, for either hand, and a common enter key located between the two hands. The system permits the entry of data in a chord-like fashion provided that the common function key is depressed during a predetermined time frame prior to or after the depression of the last data key. Efforts to arrange keyboard keys in a vertical fashion is also described in certain prior art literature. U.S. Pat. No. 3,428,747 to Alferieff entitled MAN TO MACHINE COMMUNICATION KEYBOARD DEVICE discloses a keyboard arrangement in which the four digits and thumb of the right and left hands, respectively, are positioned adjacent to two sets of keyboards, each having five keys, that are vertical and substantially adjacent to each other. The keyboard system permits the entry of data into a computer, radio system, interface or the like.

Other keyboard apparatuses and systems of possible relevance include the following U.S. patents:

| | | | | |
|---|---|---|---|---|
| 329,675; | 477,062; | 506,718; | 578,785; | 753,318; |
| 1,293,023; | 1,409,386; | 1,487,115; | 1,733,605; | 1,771,953; |
| 1,932,914; | 1,936,089; | 1,998,063; | 2,012,924; | 2,028,516; |
| 2,031,017; | 2,040,248; | 2,150,364; | 2,187,592; | 2,189,023; |
| 2,190,752; | 2,192,594; | 2,200,807; | 2,282,102; | 2,312,138; |
| 2,390,414; | 2,428,605; | 2,520,142; | 2,532,228; | 2,581,665; |
| 2,616,198; | 2,634,052; | 2,641,769; | 2,718,633; | 2,823,468; |
| 2,850,812; | 2,972,140; | 3,021,611; | 3,022,878; | 3,102,254; |
| 3,166,856; | 3,184,554; | 3,197,889; | 3,225,883; | 3,234,664; |
| 3,241,115; | 3,277,587; | 3,369,643; | 3,375,497; | 3,381,276; |
| 3,428;747; | 3,466,647; | 3,507,376; | 3,526,892; | 3,582,554; |
| 3,633,724; | 3,675,513; | 3,772,597; | 3,781,802; | 3,798,599; |
| 3,818,448; | 3,831,147; | 3,831,296; | 3,833,765; | 3,879,722; |
| 3,929,216; | 3,945,482; | 3,967,273; | 3,970,185; | 3,980,823; |
| 3,982,236; | 4,042,777; | 4,067,431; | 4,074,444; | 4,132,976; |
| 4,159,471; | 4,185,282; | 4,333,097; | 4,350,055; | 4,360,892; |
| 4,467,321; | 4,494,109; | 4,516,939; | 4,655,621; | 4,680,572; |
| 4,791,408; | 4,804,279; | 5,087,910; | 5,217,311; | 5,281,966; |
| 5,361,083; | 5,459,458; | 5,486,058; | 5,459,458; | 5,515,305; |

U.S. Pat. No. 5,642,108, and an IBM Technical Disclosure Bulletin Vol. 18 No. 12 dated May 1976 entitled; DIGITAL X TYPEWRITER KEYBOARD which discloses two sets of five ergonomicly arranged keys for each hand, where each key is operated by one of the ten digits on the left and right hands. The two thumb keys each produce a space. The eight finger keys use a three position switch (down, away and toward) or a five position switch as home row keys. Downward activation produces home row data, away activation produces top alphabetic row data and toward activation produces bottom row data found on the QWERTY keyboard.

While the foregoing all appear to represent improvements in the art of keyboard systems, they nevertheless tend to be difficult to learn and difficult to use, especially by individuals who are sight, hearing, learning or motion impaired. Of all the patents and technologies researched, none use or claim an eight bit binary computer code used as a data entry means. The most relevant technologies to this patent application are IBM's three copyrighted seven bit codes (excluding the parity bit); the eight bit EBCDIC computer code (Extended Binary Coded Decimal Interchange Code), the eight bit ASCII (American Standard Code for Information Interchange) code and the extended ASCII computer code. The eight dot computer braille code is a top dot configured code and is read as an entire cell from top to bottom.

### SUMMARY OF THE INVENTION

Briefly described, the present invention uses an eight bit binary code arrangement, read from left to right, on at least eight sensors using a four bit binary code combined with a four bit binary code system, read from left to right, to produce data. The first left binary bit of the binary code has the numeric value of one, the second left binary bit has the numeric value of two, the third left binary bit has the numeric value of four, the fourth left binary bit has the numeric value of eight, the fifth right binary bit has the numeric value of sixteen, the sixth right binary bit has the numeric value of thirty-two, the seventh right binary bit has the numeric value of sixty-four, and the last eighth right binary bit has the numeric value of one hundred and twenty-eight.

The present invention comprises an eight bit binary code for use as an alternative eight dot braille arrangement, an alphanumeric data entry system and method for chordic eight key or eight sensor binary keyboards or a method of finger braille communication for the deaf-blind.

Activation of at least one sensor enters an eight sensor data entry mode. Activation of at least one sensor can be an “ON” button, a “hot” key on a device, a mode change button, etc. Activating at least one sensor of at least eight sensors enters an eight sensor data entry mode. Activation of at least one sensor can be an “ON” button, a “hot” key on a device, a mode change button, etc. Activating all eight sensors enters an eight sensor data entry mode. Activation of all eight sensors can be eight sensors on a keyboard, eight sensors on a split space bar keyboard, eight sensors on a touch screen data entry device, etc.

The present invention produces a data character, function or data character string (macro) by activating at least one sensor of the eight sensors used. Activating at least one sensor of the eight sensors followed by the activation of at least one sensor of the eight sensors produces a secondary data character (upper-case letters/extended character sets), a function or a data character string (macro).

Activating at least one sensor of a first set of four sensors combined with an unused second set of four sensors produces a vowel. Activating at least one sensor of a first set of four sensors combined with the activation of at least one sensor of a second set of four sensors produces a vowel or a vowel with a diacritical mark. Activating at least one sensor of a first set of four sensors combined with the activation of at least one sensor of a second set of four sensors produces a consonant. An unused first set of four sensors combined with the activation of at least one sensor of a second set of four sensors produces a space. An unused first set of four sensors combined with the activation of at least one sensor of a second set of four sensors produces a punctuation mark. Activating at least one sensor of a first set of four sensors combined with the activation of at least one sensor of a second set of four sensors produces a symbol. Activating at least one sensor of a first set of four sensors combined with the activation of all the sensors of a second set of four sensors produces a number or a math function. Activating at least one sensor of a first set of four sensors combined with the activation of all the sensors except one sensor of a second set of four sensors produces a function.

The present invention also uses a split space bar keyboard as a data entry device where the fourth left binary bit has the numeric value of eight and is a left thumb sensor or a left space bar, and the fifth right binary bit has the numeric value of sixteen and is a right thumb sensor or a right space bar.

Any apparatus for entering data on at least eight sensors or on any two sensor apparatus moves an object in a first direction by activating a left sensor and moves an object in a second opposite direction by activating a right sensor.

Any apparatus for entering data on at least eight sensors or on any two sensor apparatus moves an object to the left by activating a left sensor and moves an object to the right by activating a right sensor. Any apparatus for entering data on at least eight sensors or on any two sensor apparatus rotates an object to the left by activating a left sensor and rotates an object to the right by activating a right sensor. Any apparatus for entering data on at least eight sensors or on any two sensor apparatus moves an object backward by activating a left sensor and moves an object forward by activating a right sensor. Any apparatus for entering data on at least eight sensors or on any two sensor apparatus moves an object forward by activating a left sensor and activating a right sensor simultaneously. Any apparatus for entering data on at least eight sensors or on any two sensor apparatus moves an object backward by activating a left sensor and a right sensor simultaneously followed by activating a left sensor and a right sensor simultaneously.

Any apparatus for entering data on at least eight sensors or on any two sensor apparatus moves the cursor to the left activating a left sensor and moves the cursor to the right by activating a right sensor. Any apparatus for entering data on at least eight sensors or on any two sensor apparatus deletes data to the left of the cursor by activating a left sensor and deletes data to the right of the cursor by activating a right sensor. Any apparatus for entering data on at least eight sensors or on any two sensor apparatus reverses the last change by activating a left sensor and reverses the last undo by activating a right sensor.

Any apparatus for entering data on at least eight sensors or on any two sensor apparatus exits a first data entry mode and enters a cursor movement mode by activating a left thumb sensor and a right thumb sensor simultaneously, followed by the activation of a left thumb sensor moves the cursor to the left and activation of a right thumb sensor moves a cursor to the right. Activating a left thumb sensor and a right thumb sensor simultaneously exits a cursor movement mode and enters a delete mode, followed by the activation of a left thumb sensor deletes data to the left of a cursor and activating a right thumb sensor deletes data to the right of a cursor.

Activating a left thumb sensor and a right thumb sensor simultaneously exits a delete mode and re-enters a first data entry mode.

One preferred feature of the present invention uses at least eight sensors to produce secondary types of data by exiting a first mode and shifting into a second mode by the entry of at least one data character. The shift function is included in the eight sensor code allowing the ability to use the shift for entering secondary data sets. Shifting into a secondary mode like the bold, italics, underline, etc. mode, is produced by entering the b, i, u, etc.

Another feature of the present invention uses at least eight sensors to produce secondary types of language script data sets by exiting a first mode and shifting into a second mode by entering the language code data character string to produce a secondary language script data set. Entering the country code data character string produces a secondary language script data set. Entering the country's area code data character string produces a secondary language script data set.

The system and method of the invention is logically developed and implemented so that it is easy to learn and quick to use, especially for those who are handicapped or sight impaired.

These and other features of the present invention will be more fully understood by reference to the following drawings.

### BRIEF DESCRIPTION OF THE DRAWINGS

FIGS. 1A-1P. Illustrates one preferred arrangement of the eight bit code embodiment of the disclosed invention.

FIG. 2. Illustrates a the frequency of letters used in the English language found in (a)press reporting, (b)religious writing, (c)scientific writing, (d)general fiction, (e)word averages and (f)Morse Code.

FIG. 3A. Illustrates one preferred layout of the eight bit code embodiment for lower-case letters.

FIG. 3B. Illustrates one preferred layout of the eight bit code embodiment for upper-case letters.

FIG. 3C. Illustrates one preferred layout of the eight bit code embodiment for punctuation.

FIG. 3D. Illustrates one preferred layout of the eight bit code embodiment for containment chords.

FIG. 3E. Illustrates one preferred layout of the eight bit code embodiment for horizontal and vertical lines.

FIG. 3F. Illustrates one preferred layout of the eight bit code embodiment for numbers.

FIG. 3G. Illustrates one preferred layout of the eight bit code embodiment for common math functions.

FIG. 3H. Illustrates one preferred layout of the eight bit code embodiment for functions.

FIG. 3I. Illustrates one preferred layout of the eight bit code embodiment for foreign letters.

FIG. 3J. Illustrates one preferred layout of the eight bit code embodiment for monetary symbols.

FIG. 3K. Illustrates one preferred layout of the eight bit code embodiment for control elements.

FIG. 3L. Illustrates one preferred layout of the eight bit code embodiment for symbols.

FIG. 4A. Illustrates one preferred arrangement of the eight bit code embodiment as a tactile eight dot braille cell on the bottom and the standard six dot braille cell on top. The standard six dot braille requires only one cell to represent lower-case letters and requires two cells to represent upper-case letters.

FIG. 4B. Illustrates one preferred arrangement of the eight bit code embodiment as a tactile eight dot braille cell on the bottom and the standard six dot braille cell on top. The standard six dot braille requires two cells to represent numbers.

FIG. 4C. Illustrates one preferred arrangement of the eight bit code embodiment as a tactile eight dot braille cell on the bottom and the standard six dot braille cell on top. The standard six dot braille requires only one cell to represent some punctuation and very few symbols.

### DETAILED DESCRIPTION OF THE PREFERRED EMBODIMENT

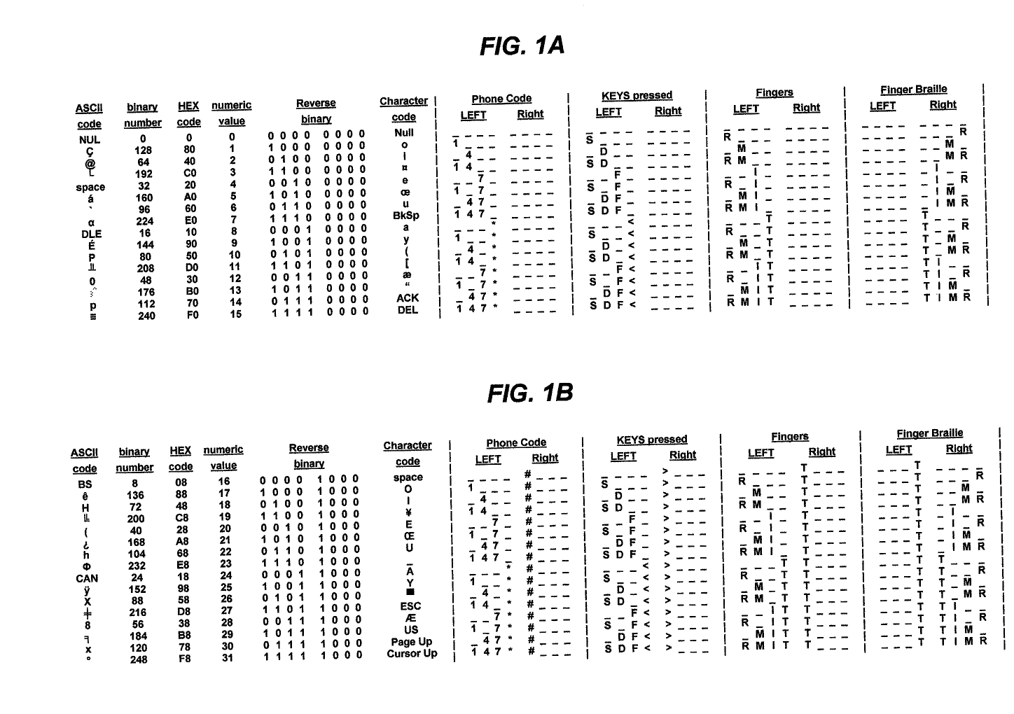

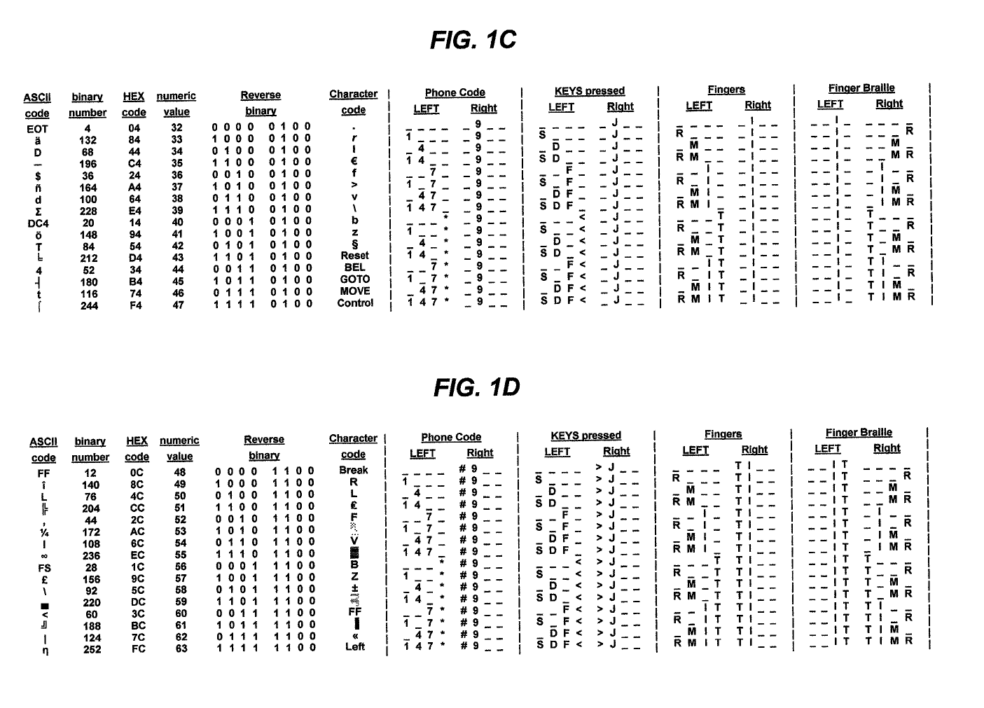

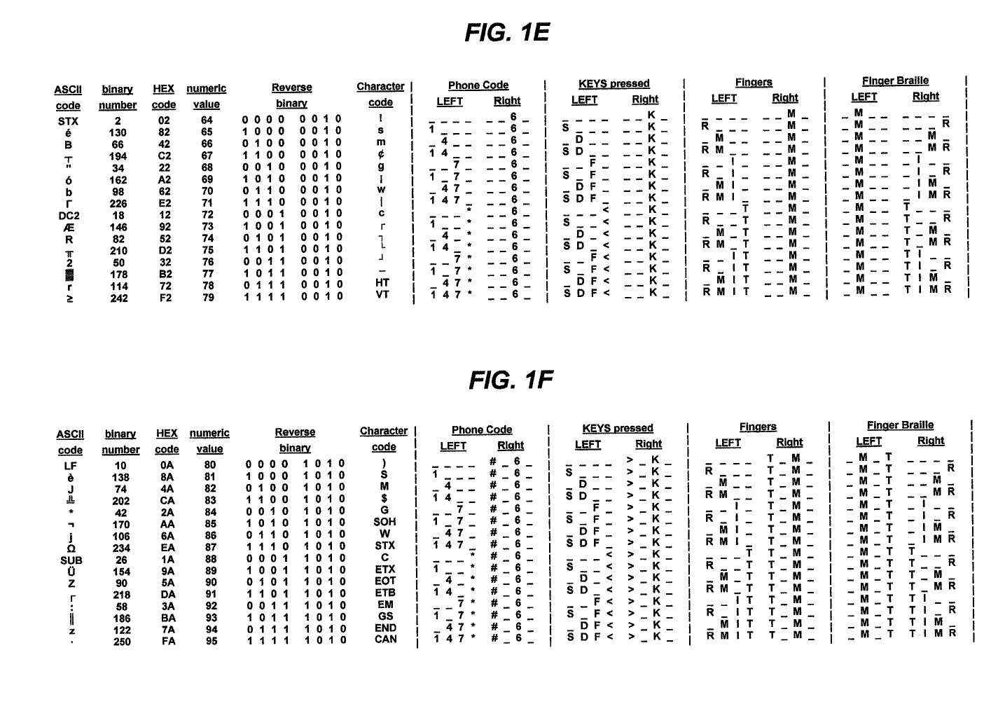

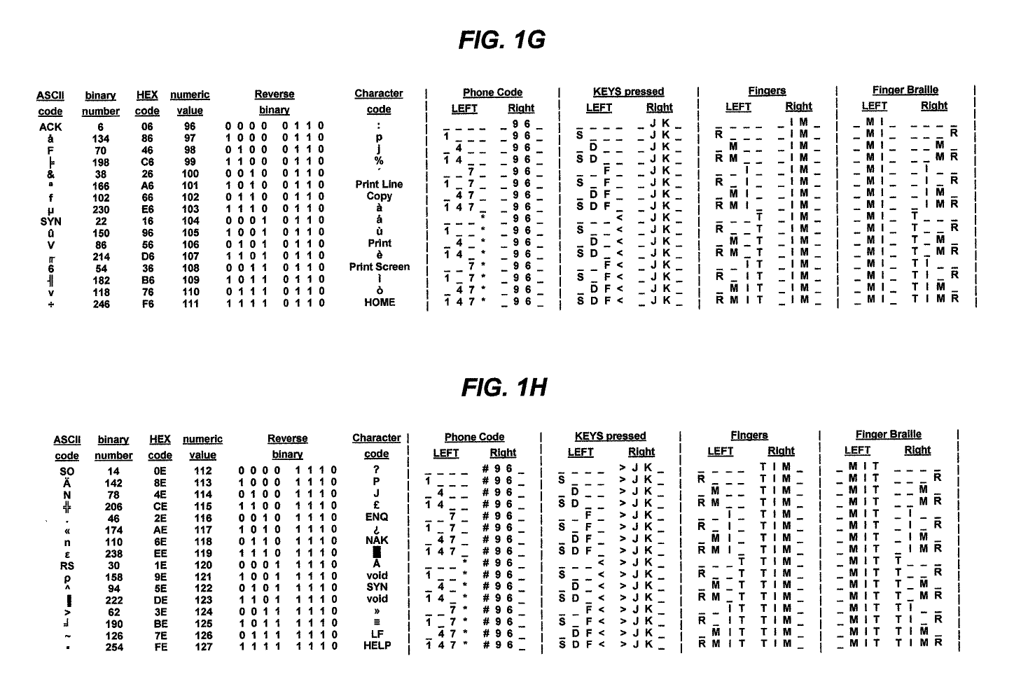

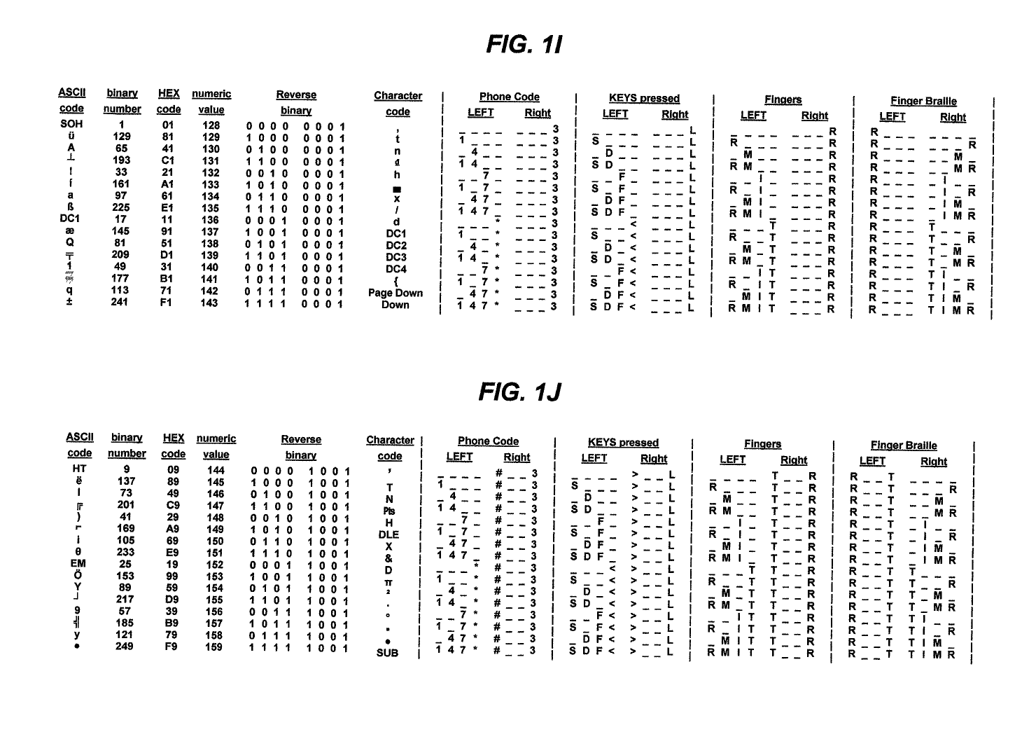

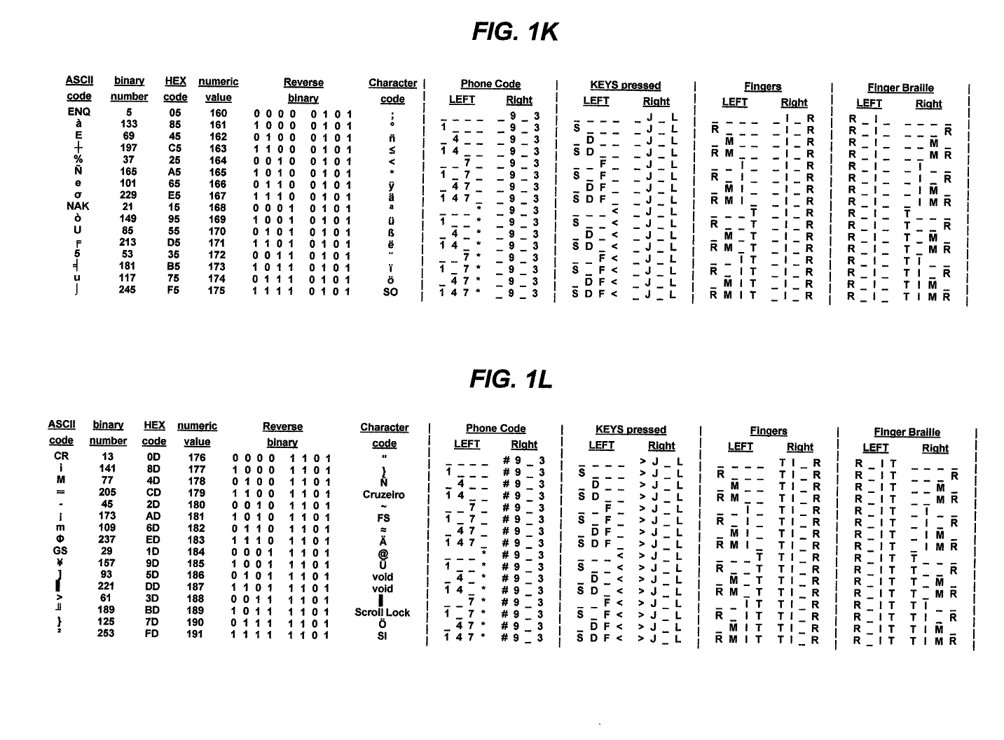

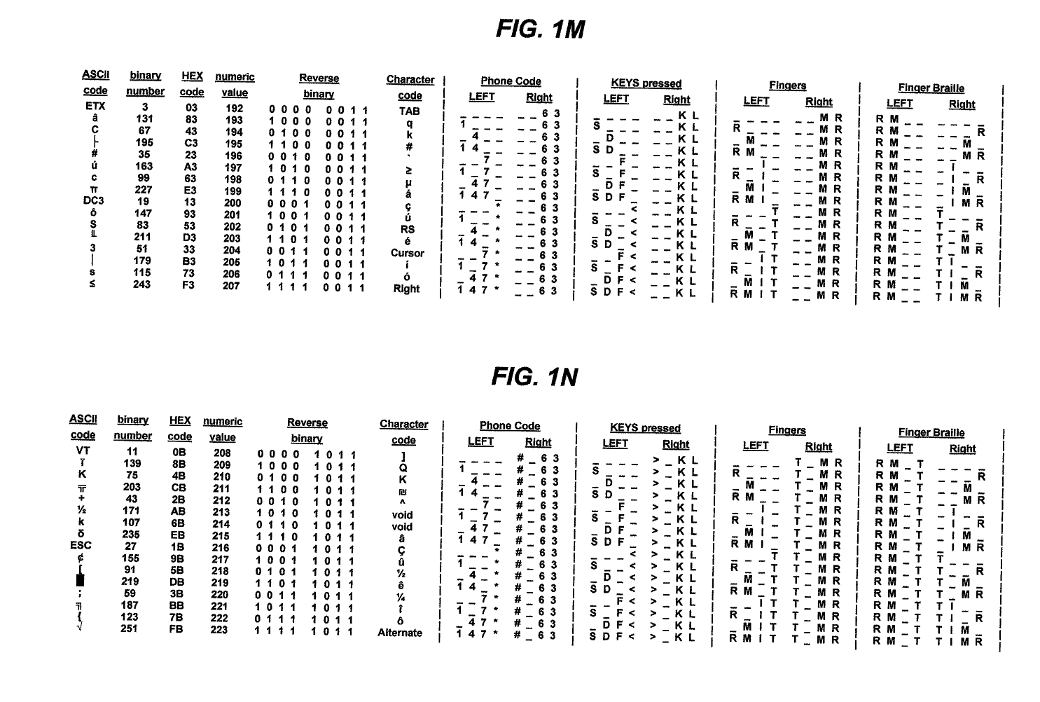

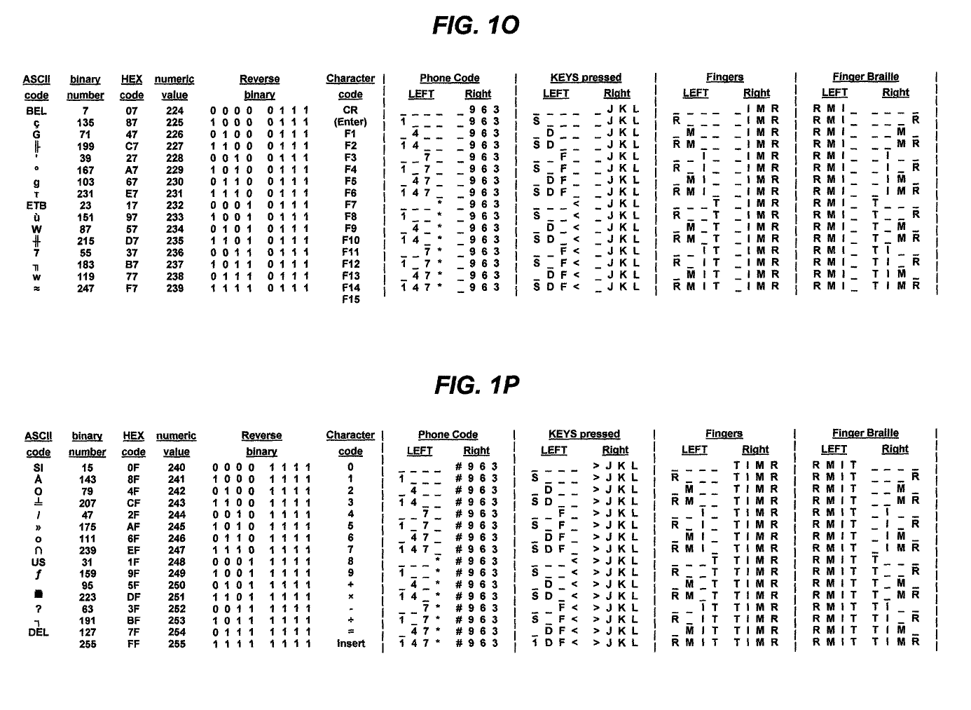

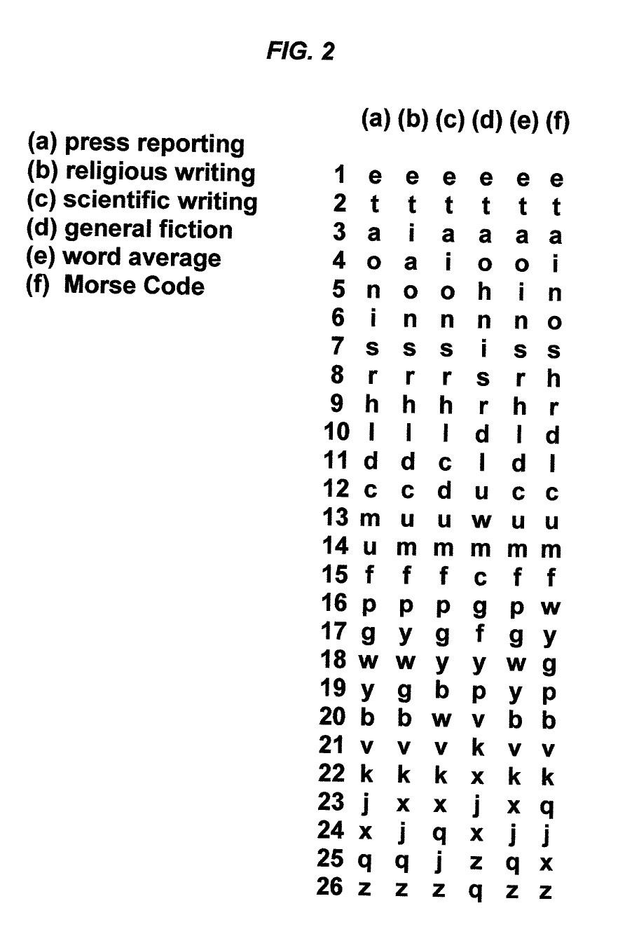

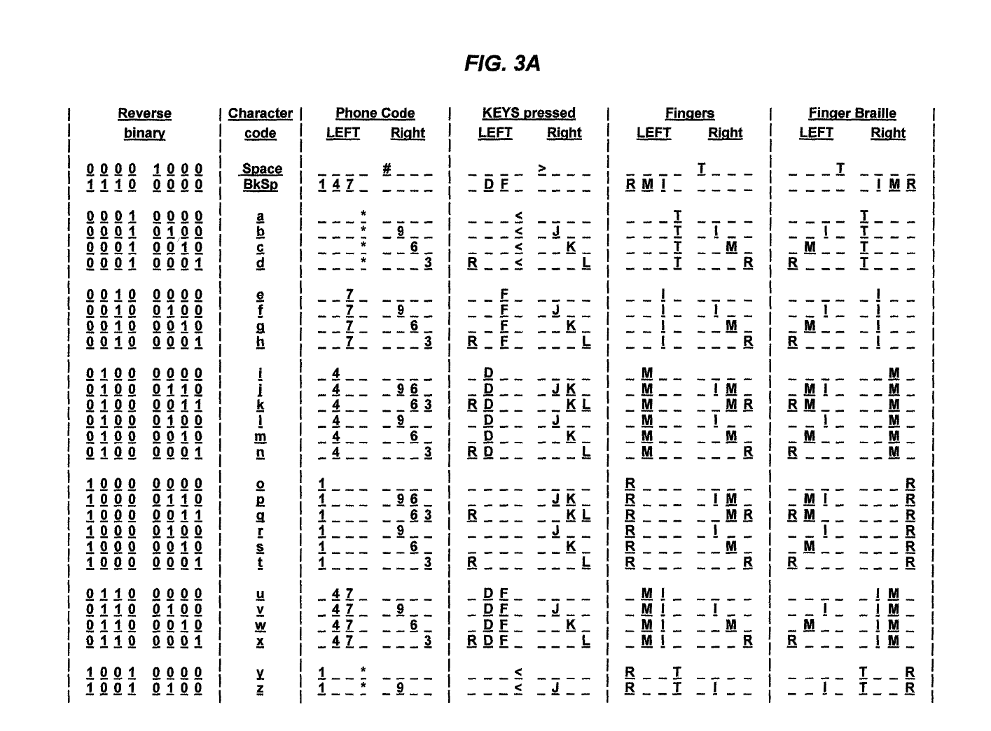

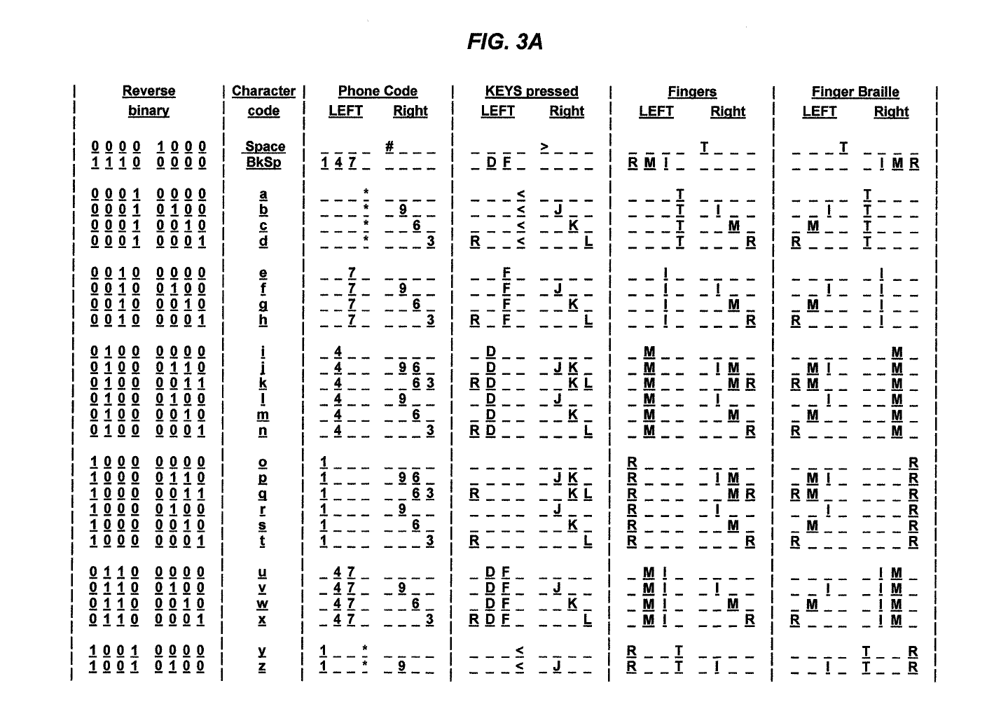

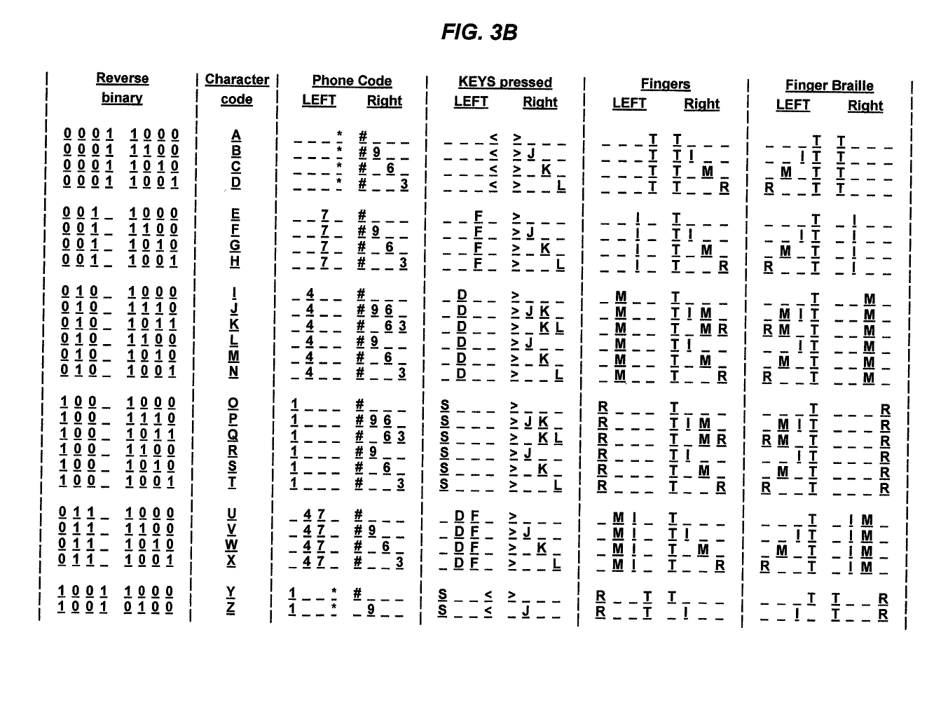

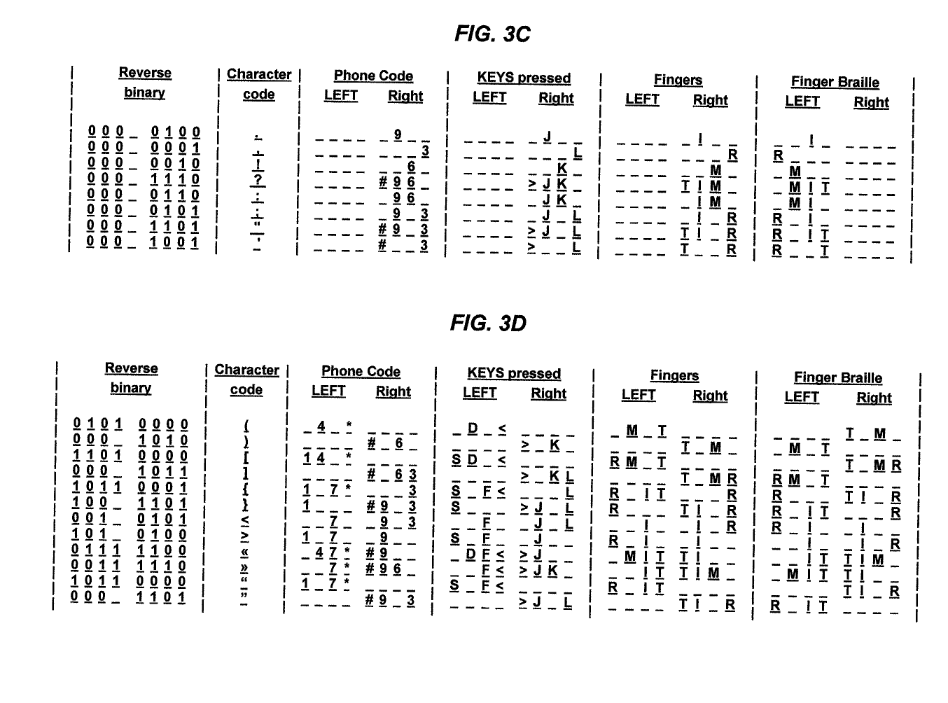

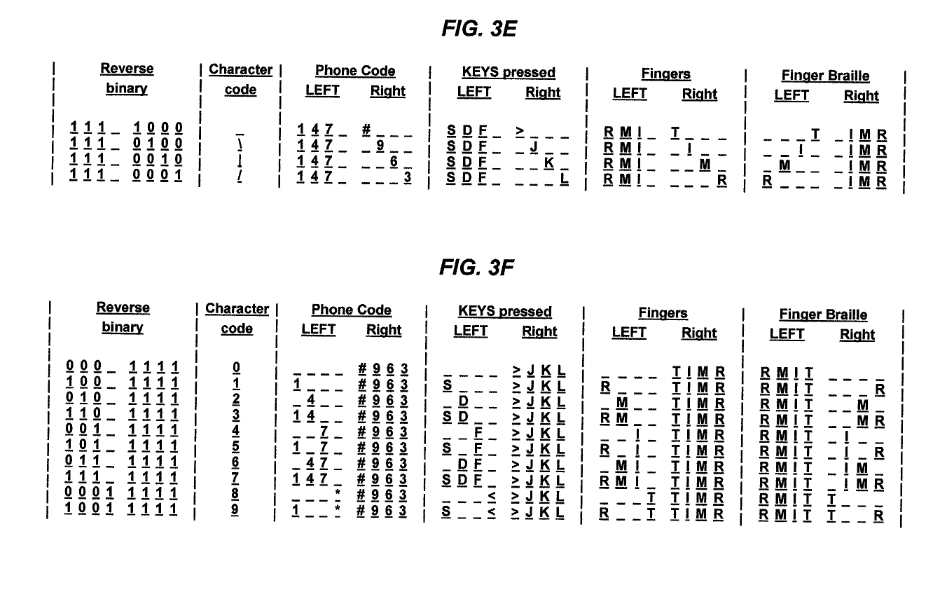

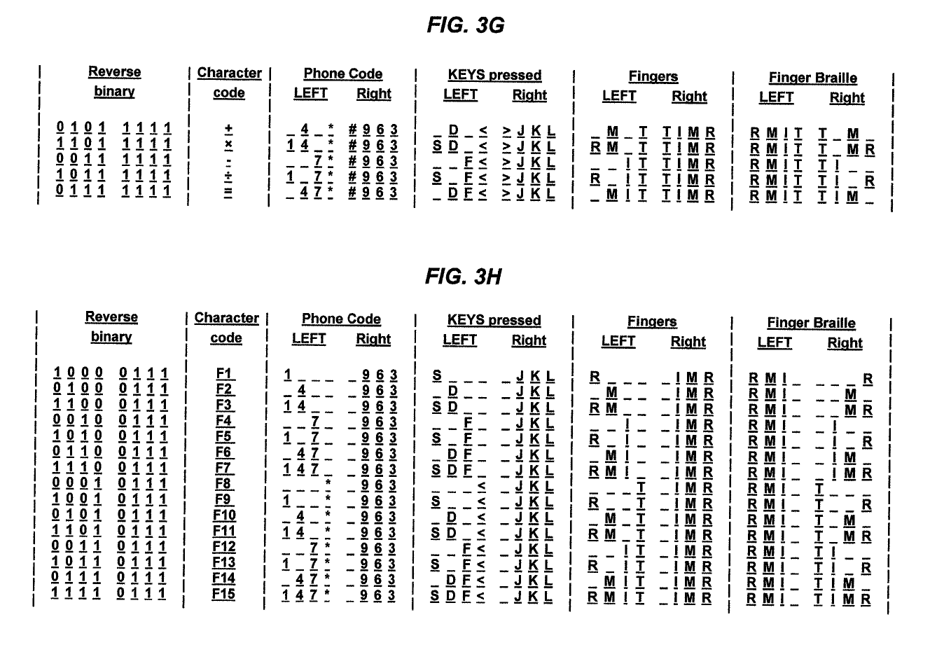

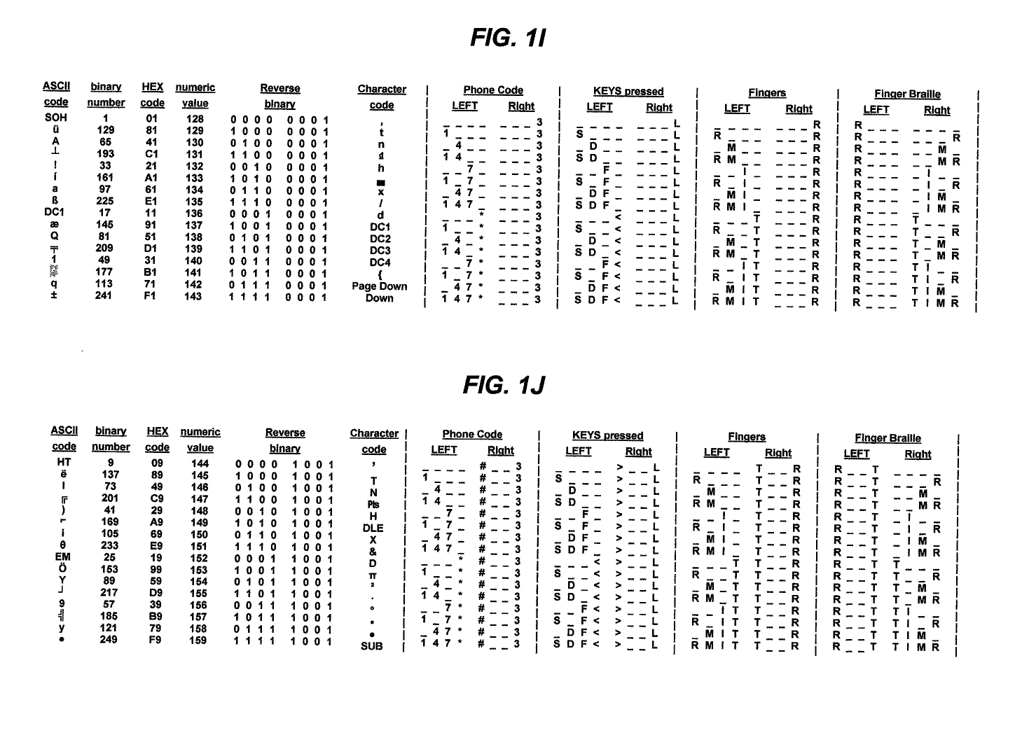

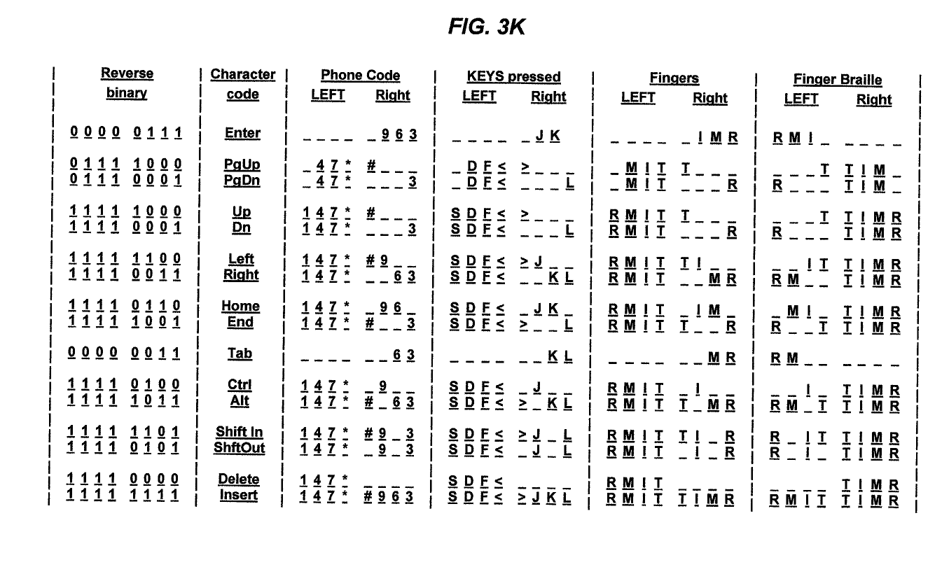

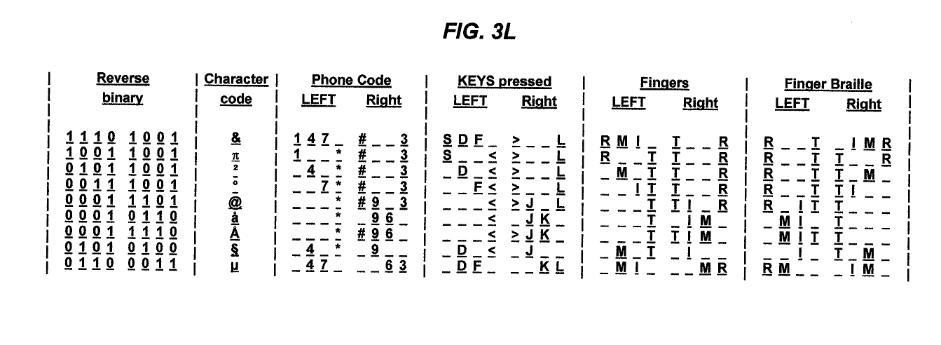

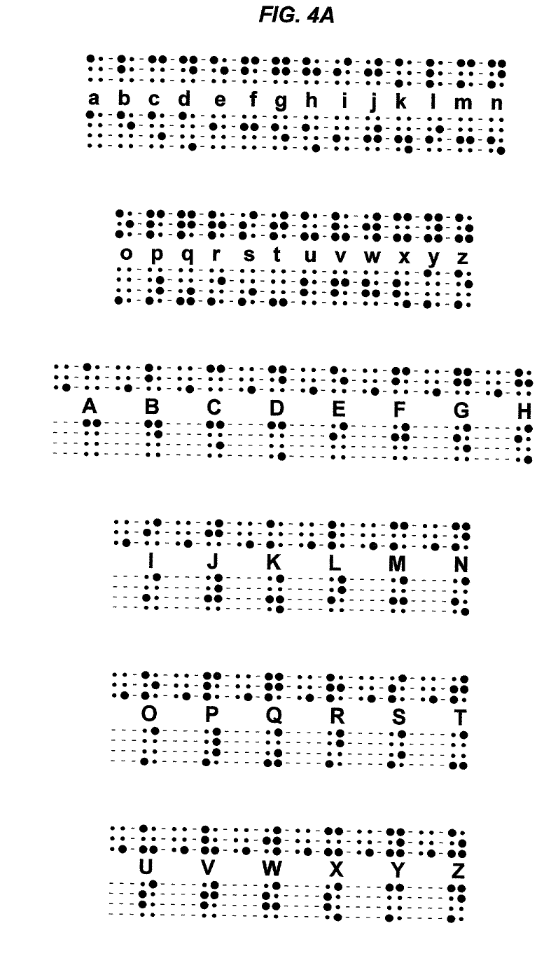

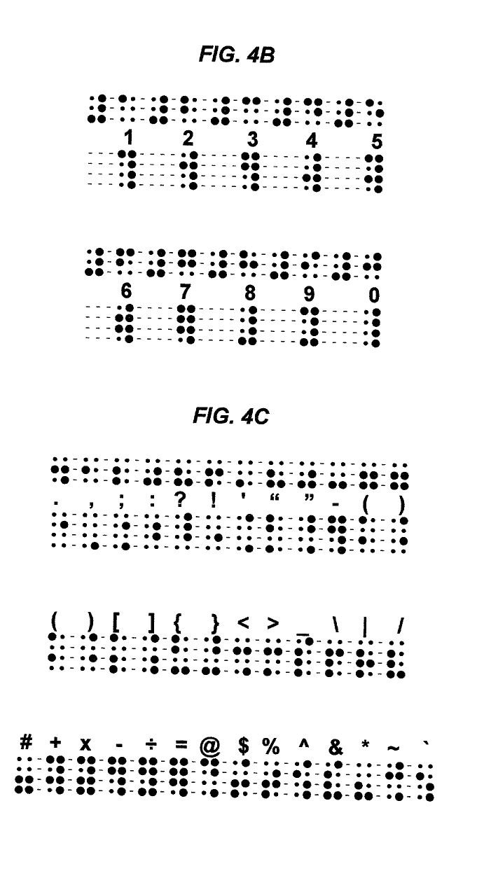

During the course of this description, the reverse binary numeric value (#0)-(#255) will be used to identify like elements according to the different figures and tables which illustrate the invention. For ease of discussion, during the course of this description, the Phone Code, the left (1-4-7-*) and right (#-9-6-3) rows on a standard twelve button phone, will also be used to easily identify like elements according to the different figures and tables which illustrate the invention. The correlation between the Reverse binary (code), KEYS pressed (QWERTY keyboard), Fingers (used) and Finger Braille (sender) tables is understood as the same code arrangement with different representations. In the KEYS pressed for the QWERTY keyboard table, “<” is the left space bar and “>” is the right space bar. A useful mnemonic technique is to remember the preferred right hand digit representation is by the phonetic word TIMR (timer) which stands for the thumb (T), index (I), middle (M), and ring (R) digits. In order to more fully understand the invention, the preferred embodiment of the invention is shown in FIGS. 1A-1P and is restructured for easier learning and memorization in FIGS. 3A-3L. FIG. 2 shows the frequency of letters used in the English language and the mnemonic logic of invention shown in FIGS. 3A-3L. The preferred embodiment of the invention is also shown in FIGS. 4A-4B as eight dot braille arrangement.

The present invention uses an eight bit binary code arrangement read from left to right on at least eight sensors using a four bit binary code combined with a four bit binary code system, read from left to right, to produce data. The first left binary bit of the binary code has the numeric value of one and is preferably a ring digit sensor, the second left binary bit has the numeric value of two and is preferably a middle digit sensor, the third left binary bit has the numeric value of four and is preferably an index digit sensor, the fourth left binary bit has the numeric value of eight and is preferably a thumb digit sensor, the fifth right binary bit has the numeric value of sixteen and is preferably a thumb digit sensor, the sixth right binary bit has the numeric value of thirty-two and is preferably an index digit sensor, the seventh right binary bit has the numeric value of sixty-four and is preferably a middle digit sensor, and the last eighth right binary bit has the numeric value of one hundred and twenty-eight and is preferably a ring digit sensor.

One preferred arrangement of the eight bit code embodiment is illustrated in FIGS. 1A-1P. The data entry keyboard system includes at least eight binary sensors divided up into two sets of four binary sensors each. A first set of four sensors includes four binary sensors which are preferably adapted to be depressed or activated, respectively, by the ring digit, middle digit, index digit and thumb digit of the first preferred left hand group of the operator. The little digit of the first preferred left hand group is not used according to the preferred embodiment, but can be used instead of the thumb. Similarly, a second set includes the following four binary sensors which are preferably adapted to be depressed or activated, respectively, by the thumb digit, index digit, middle digit and ring digit of the second preferred right hand group of the operator. The little digit of the second preferred right hand group is not used, according to the preferred embodiment, but can be used instead of the thumb.

The present invention comprises an eight bit binary code for use as an alternative eight dot braille arrangement, an alphanumeric data entry system and method for chordic eight key or eight sensor binary keyboards or a method of finger braille communication for the deaf-blind.

Activation of at least one sensor enters an eight sensor data entry mode. Activation of at least one sensor can be an “ON” button, a “hot” key on a device, a mode change button, etc. Activating at least one sensor of at least eight sensors enters an eight sensor data entry mode. Activation of at least one sensor of the eight sensors used can be an “ON” button, a “hot” key on a device, a mode change button, etc. Activating all eight sensors enters an eight sensor data entry mode. Activation of all eight sensors can be eight sensors on a keyboard, eight sensors on a split space bar keyboard, eight sensors on a touch screen data entry device, etc.

The present invention produces a data character, function or data character string (macro) by activating at least one sensor of the eight sensors used. Activating at least one sensor of the eight sensors combined with the activation of at least one sensor of the eight sensors produces a secondary data character (upper-case letters/extended character sets), a function or a data character string (macro).

The entry of vowels is produced with a first group of four binary sensors activated by four digits of the first group or preferred left hand. The entry of consonants is produced with a second group of four binary sensors activated by four digits of the second group or preferred right hand in simultaneous combination with the consonant's preceding binary vowel chord produced on a first group of four binary sensors activated by the four digits of the first group or preferred left hand.

Activating at least one sensor of a first set of four sensors combined with an unused second set of four sensors produces a vowel. Activating at least one sensor of a first set of four sensors combined with the activation of at least one sensor of a second set of four sensors produces a vowel or a vowel with a diacritical mark found in non-English alphabet based languages.

The vowels “a”, “e”, “i”, and “o” are produced by a binary key or sensor of a first set of four binary sensors activated by a first group of four digits of the first preferred left hand from right to left by independently activating the preferred thumb digit for the “a”, the preferred index digit for the “e”, the preferred middle digit for the “i” or preferred ring digit for the “o”, respectively, of the first group of four digits of the preferred left first hand group against the corresponding binary key or sensor of the first set of four binary sensors. The vowel “u” is produced by simultaneously activating the two inside binary sensors of a first set of four binary sensors by the two inside digits, the preferred index and middle digit of the first group of four digits of the preferred left first hand group. The vowel “y” is produced by simultaneously activating the two outside binary sensors of a first set of four binary sensors by the two outside digits, the preferred ring and thumb digits of the first group of four digits of the preferred left first hand group.

Lower-case letters are produced according to the table illustrated in FIG. 3A. The vowels “a” (#8), “e” (#4), “i” (#2) and “o” (#1) are produced by independently activating, respectively, the four binary sensors (*), (7), (4) and (1) of the preferred left first set by the preferred thumb digit (*), the preferred index digit (7), the preferred middle digit (4) and the preferred ring digit (1) on the preferred left first hand group, respectively. The vowel “u” (#6) is produced by simultaneously activating the two inner binary senors by the middle digit (4) and the index digit (7). These are the two inside digits of the preferred left first hand group and is logically suggestive of the vowel “u” used in sign language for the deaf. The occasional vowel “y” (#9) is produced by simultaneously activating the two outer binary senors by the ring digit (1) and the thumb digit (*). These are the two outside digits of the preferred left first hand group and is logically suggestive of the vowel “y” used in sign language for the deaf.

All consonants are produced by a second set of four binary sensors by depression or activation with the preferred right second hand group binary chords in simultaneous combination with binary vowel chords produced on the first set of four binary sensors by the preferred left first hand group. The keyboard system and method takes advantage of the fact that the vowels “a” (#8), “e” (#4), “i” (#2), “o” (#1), “u” (#6)” and “y” (#9) are somewhat evenly distributed throughout the alphabet separated by either three or five consonants in each case. There are five consonants following the vowels “i” and “o”. In the vowel “i” binary consonant chord grouping, the consonants “1” (#34), “m” (#66) and “n” (#130) are the consonants more frequently used, and in the vowel “o” binary consonant chord grouping, the consonants “r” (#33), “s” (#65) and “t” (#129) are the consonants more frequently used. Therefore, the least used consonants “j” (#98), “k” (#194) and “p” (#97), “q” (#193) are given an extra binary bit each for their preferred right second hand group binary consonant chords. FIG. 3A. is a table summarizing the manner in which lower case English language alphabet letters “a” (#8) through “z” (#41) are produced; either by use of the first set of four binary sensors depressed or activated by the preferred left first hand group exclusively (in the case of producing vowels), or through the use of the first set of four binary sensors depressed or activated by the preferred left first hand group in simultaneous combination with the second set of four binary sensors depressed or activated by the preferred right second hand group to produce consonants.

Activating at least one sensor of a first set of four sensors combined with the activation of at least one sensor of Isis a second set of four sensors produces a consonant.

Consonants are produced by simultaneously producing a binary vowel chord with the first set of four binary sensors by a first group of four digits of the preferred left first hand group and simultaneously activating the appropriate binary sensors of a second set of four binary sensors with the second group of four digits, the preferred thumb, index, middle or ring digit or digits of the preferred right second hand group. Because the vowels a, e, i, o, u and y are relatively evenly distributed throughout the alphabet, it makes logical sense to form the consonants “b” (#40), “c” (#72) and “d” (#136) with the depression or activation of a binary key or sensor by the preferred thumb digit of the preferred left first hand group, the vowel “a” (#8), in simultaneous combination with the depression or activation of a binary key or sensor of a second set of four binary sensors by the index digit for the consonant “b”, middle digit for the consonant “c” and ring digit for the consonant “d”, respectively, of the second group of four digits of the preferred right second hand group.

An unused first set of four sensors combined with the activation of at least one sensor of a second set of four sensors produces a space. Independent activation of the first preferred right thumb binary key or sensor (#) produces a “space”.

Lower-case letters are produced according to the table illustrated in FIG. 3A.

Activating (#) produces “space” (#16),

activating (*) produces “a” (#8),

activating (*) (9) produces “b” (#40),

activating (*) (6) produces “c” (#72),

activating (*) (3) produces “d” (#136),

activating (7) produces “e” (#4),

activating (7) (9) produces “f” (#36),

activating (7) (6) produces “g” (#68),

activating (7) (3) produces “h” (#132),

activating (4) produces “i” (#2),

activating (4) (9) (6) produces “j” (#98),

activating (4) (6) (3) produces “k” (#194),

activating (4) (9) produces “l” (#34),

activating (4) (6) produces “m” (#66),

activating (4) (3) produces “n” (#130),

activating (1) produces “o” (#1),

activating (1) (9) (6) produces “p” (#97),

activating (1) (6) (3) produces “q” (#193),

activating (1) (9) produces “r” (#33),

activating (1) (6) produces “s” (#65),

activating (1) (3) produces “t” (#129),

activating (4) (7) produces “u” (#6),

activating (4) (7) (9) produces “v” (#38),

activating (4) (7) (6) produces “w” (#70),

activating (4) (7) (3) produces “x” (#134),

activating (1) (*) produces “y” (#9), and

activating (1) (*) (9) produces “z” (#41).

Independent activation of the first preferred right thumb binary key or sensor (#) produces a “space”. Activation of the first preferred right thumb binary key or sensor (#) produces the “Shift” function when combined with a vowel or a consonant.

Capital letters are produced according to the table illustrated in FIG. 3B.

Activating (#) produces “space” (#16),

activating (*) (#) produces “A” (#24),

activating (*) (#) (9) produces “B” (#56),

activating (*) (#) (6) produces “C” (#88),

activating (*) (#) (3) produces “D” (#152),

activating (7) (#) produces “E” (#20),

activating (7) (#) (9) produces “F” (#52),

activating (7) (#) (6) produces “G” (#84),

activating (7) (#) (3) produces “H” (#148),

activating (4) (#) produces “I” (#18),

activating (4) (#) (9) (6) produces “J” (#114),

activating (4) (#) (6) (3) produces “K” (#210),

activating (4) (#) (9) produces “L” (#50),

activating (4) (#) (6) produces “M” (#82),

activating (4) (#) (3) produces “N” (#146),

activating (1) (#) produces “O” (#17),

activating (1) (#) (9) (6) produces “P” (#113),

activating (1) (#) (6) (3) produces “Q” (#209),

activating (1) (#) (9) produces “R” (#49),

activating (1) (#) (6) produces “S” (#81),

activating (1) (#) (3) produces “T” (#145),

activating (4) (#) (7) produces “U” (#22),

activating (4) (#) (7) (9) produces “V” (#54),

activating (4) (#) (7) (6) produces “W” (#86),

activating (4) (#) (7) (3) produces “X” (#150),

activating (1) (#) (*) produces “Y” (#25), and

activating (1) (#) (*) (9) produces “Z” (#57).

An unused first set of four sensors combined with the activation of at least one sensor of a second set of four sensors produces a punctuation mark.

Shown in the table in FIG. 3c, punctuation marks are produced using only the second set of four binary sensors depressed or activated by the preferred right second hand group. The logic behind using the preferred right second hand group only is that most punctuation occurs at the far right end of a group of words or a sentence.

Punctuation is produced according to the table illustrated in FIG. 3C.

Activating (9) produces “.” (#32),

activating (3) produces “,” (#128),

activating (6) produces “!” (#64),

activating (#) (9) (6) produces “?” (#112),

activating (9) (6) produces “:” (#96),

activating (9) (3) produces “;” (#160),

activating (#) (9) (3) produces ““” (#176), and

activating (#) (3) produces “’” (#144).

Activating at least one sensor of a first set of four sensors combined with the activation of at least one sensor of a second set of four sensors produces a symbol.

Monetary symbols are produced according to the table illustrated in FIG. 3J.

Activating (1) (4) (6) produces “¢” (#67),

activating (1) (4) (3) produces “ [symbol] ” (#131),

activating (1) (4) produces “¤” (#3),

activating (1) (4) (9) produces “ [symbol] ” (#35),

activating (1) (4) (#) (9) produces “ [symbol] ” (#51),

activating (1) (4) (#) (9) produces “%” (#99),

activating (1) (4) (6) (3) produces “#” (#195),

activating (1) (4) (#) (9) (6) produces “£” (#115),

activating (1) (4) (#) (6) produces “$” (#83),

activating (1) (4) (#) produces “¥” (#19), and

activating (4) (*) (#) (6) produces “*” (#165).

It is possible to choose a variety of data entry choices including containment groups, movement chords, operating chords (e.g., enter, tab, shift, insert, etc.), Latin based foreign language letters, consonants and punctuation, punctuation marks, monetary symbols, symbols and graphics, chords, containment chords, etc.

For example, the table in FIG. 3H illustrates certain binary containment chord groups that have mirror image binary chords. Containment groups are instructions like brackets [ ], parentheses ( ), etc. It is also useful to provide the common movement instructions such as moving a cursor up or down, tab, home,. page up or down, etc.

Containment chords are produced according to the table illustrated in FIG. 3D.

Activating (4) (*) produces “(” (#10),

activating (#) (6) produces “)” (#80),

activating (1) (4) (*) produces “[” (#11),

activating (#) (6) (3) produces “]” (#208),

activating (1) (7) (*) (3) produces “{” (#141),

activating (1) (#) (9) (3) produces “}” (#177),

activating (7) (9) (3) produces “<” (#164),

activating (1) (7) (9) produces “>” (#37),

activating (4) (7) (*) (#) (9) produces “<<” (#62),

activating (7) (*) (#) (9) (6) produces “>>” (#124),

activating (1) (7) (*) produces ““” (#13), and

activating (#) (9) (3) produces “”” (#176).

Control element chords are produced according to the table illustrated in FIG. 3K.

Activating (9) (6) (3) produces “Enter” (#7),

activating (1) (4) (*) (#) produces “Esc” (#27),

activating (6) (3) produces “Tab” (#192),

activating (4) (7) (*) (#) produces “PgUp” (#30),

activating (4) (7) (*) (3) produces “PgDn” (#142),

activating (1) (4) (7) (*) (#) produces “Up” (#31),

activating (1) (4) (7) (*) (3) produces “Down” (#143),

activating (1) (4) (7) (*) (#) (9) produces “Left” (#63),

activating (1) (4) (7) (*) (6) (3) produces “Right” (#207),

activating (1) (4) (7) (*) (9) (6) produces “Home” (#111),

activating (4) (7) (*) (#) (6) produces “End” (#94),

activating (1) (4) (7) (*) (#) (9) (3) produces “Shift” (#191),

activating (1) (4) (7) (*) (9) (3) produces “Shift Out” (#175),

activating (1) (4) (7) (*) (9) produces “Ctrl” (#47),

activating (1) (4) (7) (*) (#) (6) (3) produces “Alt” (#223),

activating (1) (4) (7) (*) (#) (9) (6) (3) produces “Ins” (#255), and

activating (1) (4) (7) (*) produces “Delete” (#15).

Horizontal and vertical lines are produced according to the table illustrated in FIG. 3E.

Activating (1) (4) (7) (#) produces “_” (#23),

activating (1) (4) (7) (9) produces “\” (#39),

activating (1) (4) (7) (6) produces “|” (#71), and

activating (1) (4) (7) (3) produces “/” (#135).

Activating at least one sensor of a first set of four sensors combined with the activation of all the sensors of a second set of four sensors produces a number or a math function.

The system enters or produces the number mode by the simultaneous depression or activation of a second set of four binary sensors by a second group of four digits, the preferred thumb, index, middle and ring digits of the preferred right second hand group in simultaneous combination with the entry or production of the desired specific binary number chord with the four digits on the first group of four digits of the preferred left hand group. The preferred left first hand group digits enter or produce the specific chosen binary number chords between 0 and 9 in a reverse binary abacus chordic fashion with the preferred ring digit binary key or sensor of the preferred left first hand group producing the binary number “1” (#241), the preferred middle digit binary key or sensor producing the binary number “2” (#242), the preferred index digit binary key or sensor producing the binary number “4” (#244), the preferred thumb digit binary key or sensor producing the binary number “8” (#248), then using binary combinations of the first set of four binary sensors to produce the desired number. The numbers “10” (#250), “11” (#250), “12” (#250), “13” (#250) and “14” (#250) are used to produce the common math functions, where the binary number 10 chord produces the addition function “+” (#250), the binary number 11 chord produces the subtraction function “−” (#251), the binary number 12 chord produces the multiplication function “×” (#252), the binary number 13 chord produces the division function “÷” (#253) and the binary number 14 chord produces the equals function “=” (#254).

FIG. 3F. is a table illustrating the manner in which binary number chords are produced. In order to enter or produce a number, the operator substantially simultaneously depresses or activates all four binary sensors (#) (9) (6) (3) of a second set of four binary sensors depressed or activated with the preferred digits the thumb, index, middle and ring digits of the preferred right second hand group and selects the desired binary number chord for entry with the first set of four binary sensors depressed or activated by the preferred left first hand group. An unused feature of the keyboard system and method according to the preferred embodiment is that the individual numbers are produced in reverse binary notation starting with the first preferred ring digit of the preferred left first hand group and ending with the eighth preferred thumb digit. If no binary sensor of the first left set of sensors is depressed or activated, then the number “0” (#240) is produced. Depression or activation of the far left first binary key or sensor (1) by the left ring digit enters produces the number “1” (#241), assuming, of course, that all of the binary sensors (#) (9) (6) (3) of the second preferred right set of four binary sensors are or has been substantially simultaneously depressed or activated. In this fashion it is possible to enter or produce the individual numbers “0” (#240) through “9” (#249) by the simultaneous binary chordic depression or activation of all of the four binary sensors of the second set of sensors along with the appropriate depression or activation of one or more binary sensors of the first set of sensors in a reverse binary fashion to produce the desired binary number. Exiting a number mode or any mode can be achieved by using the “shift out” (#175) function. The reason that a reverse binary fashion is chosen is that it is more common to read Latin based alphanumeric data from left to right in the same fashion that letters in words are read in the English language. This keeps the data entry system and method consistent in its format and is an easier way for people to learn to enter information using the system of data entry.

Common binary math function chords are illustrated in the table of FIG. 3G. The reverse binary equivalents of the numbers “10” (#250) through “14” (#254) are used, respectively, by the number “10” (#250) binary chord to represent or produce the addition “+” symbol or function, the number “11” (#251) binary chord to represent or produce the multiplication “×” symbol or function, the number “12” (#252) binary chord to represent or produce the subtraction “−” symbol or function, the number “13” (#253) binary chord to represent or produce the division “÷” symbol or function and the number “14” (#254) binary chord to represent or produce the equals “=” symbol or function.

Numbers are produced according to the table illustrated in FIG. 3F.

Activating (#) (9) (6) (3) produces “0” (#240),

activating (1) (#) (9) (6) (3) produces “1” (#241),

activating (4) (#) (9) (6) (3) produces “2” (#242),

activating (1) (4) (#) (9) (6) (3) produces “3” (#243),

activating (7) (#) (9) (6) (3) produces “4” (#244),

activating (1) (7) (#) (9) (6) (3) produces “5” (#245),

activating (4) (7) (#) (9) (6) (3) produces “6” (#246),

activating (1) (4) (7) (#) (9) (6) (3) produces “7” (#247),

activating (*) (#) (9) (6) (3) produces “8” (#248),and

activating (1) (*) (#) (9) (6) (3) produces “9” (#249).

Common math functions are produced according to the table 25 illustrated in FIG. 3G.

Activating (4) (*) (#) (9) (6) (3) produces “+” (#250),

activating (1) (4) (*) (#) (9) (6) (3) produces “−” (#251),

activating (7) (*) (#) (9) (6) (3) produces “×” (#252),

activating (1) (7) (*) (#) (9) (6) (3) produces “÷” (#253), and

activating (4) (7) (*) (#) (9) (6) (3) produces “=” (#254).

Activating at least one sensor of a first set of four sensors combined with the activation of all the sensors except one sensor of a second set of four sensors produces a function.

Fifteen functions are also obtainable. The system produces the numeric function by the simultaneous depression or activation of a second set of four binary sensors by a second group of four digits, the preferred index, middle and ring digits of the preferred right second hand group in simultaneous combination with the desired specific binary number chord with the four digits on the first group of four digits of the preferred left hand group. The preferred left first hand group digits enter or produce the specific chosen binary number chords between 0 and 9 in a reverse binary abacus chordic fashion with the preferred ring digit binary key or sensor of the preferred left first hand group producing the binary number “1” (#241), the preferred middle digit binary key or sensor producing the binary number “2” (#242), the preferred index digit binary key or sensor producing the binary number “4” (#244), the preferred thumb digit binary key or sensor producing the binary number “8” (#248), then using binary combinations of the first set of four binary sensors to produce the desired number.

In order to expand the utility of the system, it is important to be able to choose from other function modes. Multifunction binary chord choices are produced according to the table illustrated in FIG. 3H. The multifunction binary chord mode choice is initiated or produced by the substantially simultaneous depression or activation of a second set of four binary sensors depressed or activated by the preferred index digit, middle digit and ring digit of the preferred right second hand group, in simultaneous combination with the appropriate reverse binary choice of chords on a second set of four binary sensors depressed or activated by the four digits of the preferred left first hand group. Up to 15 function mode choices are possible (F1-F15) given the fact that there are four binary sensors and 15 different distinct binary chordic combinations possible using four sensors, given the particular binary chordic choice. Note that the functions F1-F15 correspond one for one with the reverse binary number chosen while in the number mode by the four digits of the preferred left first hand group.

Functions are produced according to the table illustrated in FIG. 3H.

Activating (1) (9) (6) (3) produces “F1” (#225),

activating (4) (9) (6) (3) produces “F2” (#226),

activating (1) (4) (9) (6) (3) produces “F3” (#227),

activating (7) (9) (6) (3) produces “F4” (#228),

activating (1) (7) (9) (6) (3) produces “F5” (#229),

activating (4) (7) (9) (6) (3) produces “F6” (#230),

activating (1) (4) (7) (9) (6) (3) produces “F7” (#231),

activating (*) (9) (6) (3) produces “F8” (#232),

activating (1) (*) (9) (6) (3) produces “F9” (#233),

activating (4) (*) (9) (6) (3) produces “F10” (#234),

activating (1) (4) (*) (9) (6) (3) produces “F11” (#235),

activating (7) (*) (9) (6) (3) produces “F12” (#236),

activating (1) (7) (*) (9) (6) (3) produces “F13” (#237),

activating (4) (7) (*) (9) (6) (3) produces “F14” (#238), and

activating (1) (4) (7) (*) (9) (6) (3) produces “F15” (#239).

The preferred input keyboard comprises eight binary sensors arranged in two sets of four binary sensors each. The first set of four binary sensors is preferably adapted for convenient ergonomic depression or activation by the preferred thumb, index, middle and ring digits on the four digits of a first group or preferred left hand. Similarly, the second set of four binary sensors is arranged for convenient ergonomic depression or activation by four digits of a second group by the preferred thumb, index, middle and ring digits on the four digits of a second group or preferred right hand. The two sets of four binary sensors are preferably arranged where each binary key or sensor is located directly beneath the finger tip of the activating digit, of an ergonomicly positioned hand, preferably in two ergonomicly correct mirror imaged pairs to best accommodate the natural ergonomicly relaxed hand position of the digits on the hands of a data entry keyboard operator. Alternatively, the two sets may be arranged in two vertical or horizontal mirror imaged rows of adjacent crescents. The keyboard can also mimic the layout of an 8-dot braille cell character arrangement which is shown in FIGS. 4A-4C.

The present invention also uses a split space bar keyboard as a data entry device where the fourth left binary bit has the numeric value of eight and is a left thumb sensor or a left space bar, and the fifth right binary bit has the numeric value of sixteen and is a right thumb sensor or a right space bar.

One preferred keyboard embodiment includes a first set of four sensors (1) (4) (7) (*), preferably including a left space bar for activation by a left thumb and a second set of four sensors (#) (9) (6) (3), preferably including a right space bar for activation by a right thumb. The first set of four sensors (1) (4) (7) (*) includes four binary sensors which are preferably adapted to be depressed or activated, respectively, by the preferred ring digit, middle digit, index digit and thumb digit on the left hand of the operator. Similarly, the second set of four sensors (#) (9) (6) (3), includes four binary sensors which are preferably adapted to be depressed or activated, respectively, by the preferred ring digit, middle digit, index digit and thumb digit on the right hand of the operator.

Any apparatus for entering data on at least eight sensors or on any two sensor apparatus moves an object in a first direction by activating a left sensor and moves an object in a second opposite direction by activating a right sensor. Movement within a virtual reality environment can easily be obtained by using a left sensor and a right sensor. Movement for a robot or a machine can easily be obtained by using a left sensor and a right sensor. A computer mouse can be one preferred embodiment of the invention. Any apparatus for entering data on at least eight sensors or on any two sensor apparatus moves an object to the left by activating a left sensor and moves an object to the right by activating a right sensor. Any apparatus for entering data on at least eight sensors or on any two sensor apparatus rotates an object to the left by activating a left sensor and rotates an object to the right by activating a right sensor. Any apparatus for entering data on at least eight sensors or on any two sensor apparatus moves an object backward by activating a left sensor and moves an object forward by activating a right sensor. Any apparatus for entering data on at least eight sensors or on any two sensor apparatus moves an object forward by activating a left sensor and activating a right sensor simultaneously. Any apparatus for entering data on at least eight sensors or on any two sensor apparatus moves an object backward by activating a left sensor and a right sensor simultaneously followed by activating a left sensor and a right sensor simultaneously.

The same logic can be used on a data entry device for a computer, typewriter or mouse. One preferred keyboard design would be the split space bar QWERTY keyboard. Any apparatus for entering data on at least eight sensors or on any two sensor apparatus moves the cursor to the left activating a left sensor or left space bar and moves the cursor to the right by activating a right sensor or right space bar. Any apparatus for entering data on at least eight sensors or on any two sensor apparatus deletes data to the left of the cursor by activating a left sensor or left space bar and deletes data to the right of the cursor by activating a right sensor or right space bar. Any apparatus for entering data on at least eight sensors or on any two sensor apparatus reverses the last change by activating a left sensor or left space bar and reverses the last undo by activating a right sensor or right space bar.

Any apparatus for entering data on at least eight sensors or on any two sensor apparatus exits a first data entry mode and enters a cursor movement mode by activating a left thumb sensor or left space bar and a right thumb sensor or right space bar simultaneously, followed by the activation of a left thumb sensor or left space bar moves the cursor to the left and activation of a right thumb sensor or right space bar moves a cursor to the right. Activating a left thumb sensor or left space bar and a right thumb sensor or right space bar simultaneously exits a cursor movement mode and enters a delete mode, followed by the activation of a left thumb sensor or left space bar deletes data to the left of a cursor and activating a right thumb sensor or right space bar deletes data to the right of a cursor. Activating a left thumb sensor or left space bar and a right thumb sensor or right space bar simultaneously exits a delete mode and re-enters a first data entry mode.

One preferred feature of the present invention uses at least eight sensors to produce secondary types of data by exiting a first mode and shifting into a second mode by the entry of at least one data character. The one data character can be a non-English lower-case letter, where the shift produces an non-English upper-case letter. The shift function is included in the eight bit code allowing the ability to use the shift for entering secondary data sets. Shifting into (#191) a secondary mode like the bold, italics, underline, etc. mode, is produced by entering the b, i, u, etc. Exiting a mode or any modes can be achieved by using the “shift out” (#175) function.

Because there are a total of eight binary sensors, it is possible to form a total of 255 binary chordic combinations (2×2×2×2×2×2×2×2=256). These combinations are summarized in the table illustrated in FIGS. 1A-1P. If activation of the shifting chord combination is employed, “Shift” (#191), it offers the potential of entering a secondary sets of 255 unassigned eight bit binary chord groups, which can be used for a multiplicity of modes, such as different types or sizes of fonts, bold mode, italics mode, underline mode, highlight mode, language scripts, country scripts or whatever extra mode is required, a feature which substantially expands the capability of the invention. The shift function is part of the eight sensor code. Since the shift function is not used to produce an upper-case vowel or consonant, combining it with an upper-case or lower-case vowel or consonant enters a secondary keyboard mode. Producing the shift function combined with a “b” and followed by the activation of the enter function enters the bold mode. Producing the shift function combined with a “i” and followed by the activation of the enter function enters the italics mode. Producing the shift function combined with a u” and followed by the activation of the enter function enters the underline mode. Producing the shift function combined with a “h” and followed by the activation of the enter function enters the highlight mode. Producing the shift function combined with any vowel, consonant, number, function, letters, numbers, etc. and preferably followed by the activation of the enter function enters a multiplicity of possible modes. Exiting a mode or any modes can be achieved by using the “shift out” (#175) function.

Another feature of the present invention uses at least eight sensors to produce secondary types of language script data sets by exiting a first mode and shifting into a second mode by entering the language code data character string to produce a secondary language script data set. Entering the country code data character string produces a secondary language script data set. Entering the country's area code data character string produces a secondary language script data set. Exiting a mode or any modes can be achieved by using the “shift out” (#175) function.

Using the ISO Alpha-2 and Alpha-3 language codes as a way of assigning names to secondary eight bit data character sets, is one possible way of producing the secondary chordic combinations sets for any and all language alphabet scripts or character sets. Entry of the preferred Alpha-2 and Alpha-3 language codes exits the standard eight bit binary chordic data entry method mode, found in this patent application, and pD enters a secondary eight bit binary chordic data entry method mode set. Languages with extensive alphabet scripts or character sets, like Chinese, requires an eight bit binary data chord followed by an extra secondary eight bit binary data chord. Reassigning the present eight bit binary code invention arrangement, without departing from the spirit and scope of the invention as a whole, produces all language alphabet scripts or character sets.

| | | | | |
|---|---|---|---|---|
| ab | or | abk | for | Abkhazian |
| | | ace | for | Achinese |
| | | ach | for | Acoli |
| | | ada | for | Adangme |
| om | or | gal/orm | for | Afan (Oromo) |
| aa | or | aar | for | Afar |
| | | afh | for | Afrihili (Artificial language) |
| af | or | afr | for | Afrikaans |
| | | afa | for | Afro-Asiatic (Other) |
| | | aka | for | Akan |
| | | akk | for | Akkadian |
| sq | or | alb/sqi | for | Albanian |
| | | ale | for | Aleut |
| | | alg | for | Algonquian languages |
| | | ajm | for | Aljamia |
| | | tut | for | Altaic (Other) |
| | | cai | for | American, Central Indian (Other) |
| | | nai | for | American Indian, North (Other) |
| | | sai | for | American Indian, South (Other) |
| am | or | amh | for | Amharic |
| | | apa | for | Apache languages |
| ar | or | ara | for | Arabic |
| | | arc | for | Aramaic |
| | | arp | for | Arapaho |
| | | arn | for | Araucanian |
| | | sam | for | Aramaic, Samaritan |
| | | arw | for | Arawak |
| hy | or | arm/hye | for | Armenian |
| | | art | for | Artificial (Other) |
| | | afa | for | Asiatic, Afro- (Other) |
| as | or | asm | for | Assamese |
| | | ath | for | Athapascan languages |
| | | aus | for | Australian languages |
| | | map | for | Austronesian (Other) |
| | | ava | for | Avaric (Avar) |
| | | ave | for | Avestan |
| | | awa | for | Awandhi |
| ay | or | aym | for | Aymara (Aymará) |
| az | or | aze | for | Azerbaijani |
| | | nah | for | Aztec |
| | | ban | for | Balinese |
| | | bat | for | Baltic (Other) |
| | | bal | for | Baluchi |
| | | bam | for | Bambara |
| | | bai | for | Bamileke languages |
| | | bad | for | Banda |
| | | bnt | for | Bantu (Other) |
| | | bas | for | Basa (Kru) |
| ba | or | bak | for | Bashkir |
| eu | or | baq/eus | for | Basque |
| | | bej | for | Beja |
| | | bel | for | Belorussian (Belarusian) |
| | | bem | for | Bemba |
| bn | or | ben | for | Bengali (Bangla) |
| | | ber | for | Berber languages |
| | | bho | for | Bhojpuri |
| dz | | | for | Bhutani |
| bh | or | bih | for | Bihari |
| | | bik | for | Bikol |
| | | bin | for | Bini |
| bi | or | bis | for | Bislama |
| | | nob | for | Bokmål, Norwegian |
| | | bos | for | Bosnian |
| | | bra | for | Braj |
| br | or | bre | for | Breton |
| | | bug | for | Buginese |
| bg | or | bul | for | Bulgarian |
| | | bua | for | Buriat |
| my | or | bur/mya | for | Burmese |
| | | bel | for | Burushaski |
| be | | | for | Byelorussian |
| | | cad | for | Caddo |
| km | or | khm | for | Cambodian (Khmer) |
| | | car | for | Carib |
| | | spa | for | Castilian |
| ca | or | cat | for | Catalan |
| | | cau | for | Caucasian (Other) |
| | | ceb | for | Cebuano |
| | | cel | for | Celtic (Other) |
| | | cai | for | Central American Indian (Other) |
| | | chg | for | Chagatai |
| | | cmc | for | Chamic languages |
| | | cha | for | Chamorro |
| | | che | for | Chechen |
| | | chr | for | Cherokee |
| | | chy | for | Cheyenne |
| | | chb | for | Chibcha |
| | | nya | for | Chichewa |
| zh | or | chi/zho | for | Chinese |
| | | chn | for | Chinook jargon |
| | | chp | for | Chipewyan |
| | | cho | for | Choctaw |
| | | chu | for | Church Slavic |
| | | chk | for | Chuukese |
| | | chv | for | Chuvash |
| | | cop | for | Coptic |
| | | cor | for | Cornish |
| co | or | cos | for | Corsican |
| | | cre | for | Cree |
| | | mus | for | Creek |
| | | crp | for | Creoles and pidgins (Other) |
| | | cpe | for | Creoles and pidgins, English (Other) |
| | | cpf | for | Creoles and pidgins, French (Other) |
| | | cpp | for | Creoles and pidgins, Portuguese (Other) |
| hr | or | scr/hrv | for | Croatian (Serbo-Croatian) |
| | | cus | for | Cushitic (Other) |
| cs | or | ces/cze | for | Czech |
| | | dak | for | Dakota |
| da | or | dan | for | Danish |
| | | day | for | Dayak |
| | | del | for | Delaware |
| | | din | for | Dinka |
| | | div | for | Divehi |
| | | doi | for | Dogri |
| | | dgr | for | Dogrib |
| | | dra | for | Dravidian (Other) |
| | | dua | for | Duala |
| nl | or | dut/nld | for | Dutch |
| | | dum | for | Dutch, Middle (ca. 1050-1350) |
| | | dyu | for | Dyula |
| | | dzo | for | Dzongkha |
| | | efi | for | Efik |
| | | egy | for | Egyptian (Ancient) |
| | | eka | for | Ekajuk |
| | | elx | for | Elamite |
| en | or | eng | for | English |
| | | en-cokney | for | English (London docks dialect) |
| | | enm | for | English, Middle (1100-1500) |
| | | ang | for | English, Old (ca. 450-1100) |
| | | cpe | for | English-based Creoles & pidgins (Other) |
| | | esk | for | Eskimo (Other) |
| eo | or | epo/esp | for | Esperanto |
| et | or | est | for | Estonian |
| | | eth | for | Ethiopic |
| | | ewe | for | Ewe (Fon) |
| | | ewo | for | Ewondo |
| | | fan | for | Fang |
| | | fat | for | Fanti |
| fo | or | fao/far | for | Faroese |
| fj | or | fij | for | Fijian (Fiji) |
| fi | or | fin | for | Finnish |
| | | fiu | for | Finno-Ugrian (Other) |
| | | fon | for | Fon |
| fr | or | fra/fre | for | French |
| | | frm | for | French, Middel (ca. 1400-1600) |
| | | fro | for | French, Old (ca. 842-1400) |
| | | cpf | for | French-based Creoles and pidgins (Other) |
| fy | or | fry | for | Frisian |
| | | fur | for | Friulian |
| | | ful | for | Fulah |
| | | gaa | for | Ga (Gp) |
| | | gla | for | Gaelic |
| gd | or | gae/gdh | for | Gaelic (Scots) |
| gl | | | for | Galician |
| | | gag/glg | for | Gallegan |
| | | lug | for | Ganda |
| | | gay | for | Gayo |
| | | gez | for | Geez |
| ka | or | geo/kat | for | Georgian |
| de | or | deu/ger | for | German |
| | | nds | for | German, Low |
| | | gmh | for | German, Middle High (ca. 1050-1500) |
| | | goh | for | German, Old High (ca. 750-1050) |
| | | gem | for | Germanic (Other) |
| | | kik | for | Gikuyu |
| | | gil | for | Gilbertese |
| | | gon | for | Gondi |
| | | gor | for | Gorontalo |
| | | got | for | Gothic |
| | | grb | for | Grebo |
| el | or | grc | for | Greek, Ancient (to 1453) |
| | | ell/gre | for | Greek, Modern (1453- ) |
| kl | or | kal | for | Greenlandic |
| gn | or | gua/grn | for | Guarani (Guarani) |
| gu | or | guj | for | Gujarati |
| | | gwi | for | Gwich'in |
| | | hai | for | Haida |
| | | i-hak | for | Hakka |
| ha | or | hau | for | Hausa |
| | | haw | for | Hawaiian |
| he | or | heb | for | Hebrew |
| | | her | for | Herero |
| | | hil | for | Hiligaynon |
| | | him | for | Himachali |
| hi | or | hin | for | Hindi |
| | | hmo | for | Hiri Motu |
| | | hit | for | Hittite |
| hu | or | hun | for | Hungarian |
| | | hup | for | Hupa |
| | | iba | for | Iban |
| is | or | ice/isl | for | Icelandic |
| | | ibo | for | Igbo |
| | | ijo | for | Ijo |
| | | ilo | for | Iloko |
| | | nai | for | Indian, North American (Other) |
| | | cai | for | Indian, Central American (Other) |
| | | sai | for | Indian, South American (Other) |
| | | inc | for | Indic (Other) |
| | | ine | for | Indo-European (Other) |
| | | ind | for | Indonesian |
| ia | or | int/ina | for | Interlingua (Int. Auxilary Lang. Assoc.) |
| ie | or | ile | for | Interlingue |
| iu | or | iku | for | Inuktitut (Eskimo) |
| ik | or | ipk | for | Inupiak (Inupiaq) |
| | | ira | for | Iranian (Other) |
| ga | or | iri/gai | for | Irish |
| | | gle | for | Irish |
| | | mga | for | Irish, Middle (900-1200) |
| | | sga | for | Irish, Old (to 900) |
| | | iro | for | Iroquoian languages |
| it | or | ita | for | Italian |
| ja | or | jpn | for | Japanese |
| jv | or | jav/jaw | for | Javanese |
| | | jrb | for | Judeo-Arabic |
| | | jpr | for | Judeo-Persian |
| | | kab | for | Kabyle |
| | | kac | for | Kachin |
| | | kal | for | Kalaallisut |
| | | kam | for | Kamba |
| kn | or | kan | for | Kannada |
| | | kau | for | Kanuri |
| | | kaa | for | Kara-Kalpak |
| | | kar | for | Karen |
| ks | or | kas | for | Kashmiri |
| | | kaw | for | Kawi |
| kk | or | kaz | for | Kazakh |
| | | kha | for | Khasi |
| km | or | cam/khm | for | Khmer (Cambodian) |
| | | khi | for | Khoisan (Other) |
| | | kho | for | Khotanese |
| | | kik | for | Kikuyu |
| | | kmb | for | Kimbundu |
| rw | or | kin | for | Kinyarwanda |
| | | kir | for | Kirghiz |
| ky | | | for | Kirgiz |
| | | x-klingon | for | Klingon(Star Trek) |
| | | khm | for | Khmer (Cambodian) |
| | | mkh | for | Khmer, Mon-Khmer (Other) |
| | | kon | for | Kongo |
| | | kok | for | Konkani |
| ko | or | kor | for | Korean |
| | | kos | for | Kosraean |
| | | kpe | for | Kpelle |
| | | kro | for | Kru |
| | | kua | for | Kuanyama |
| | | kum | for | Kumyk |
| ku | or | kur | for | Kurdish |
| | | kru | for | Kurukh |
| | | kus | for | Kusaie |
| | | kut | for | Kutenai |
| | | lad | for | Ladino |
| | | lah | for | Lahnda |
| | | lam | for | Lamba |
| | | lan/oci | for | Langue d'oc (post 1500) |
| | | lao | for | Lao |
| lo | | | for | Laothian |
| | | lap | for | Lapp languages (Lappish) |
| la | or | lat | for | Latin |
| lv | or | lav | for | Latvian |
| | | ltz | for | Letzeburgesch |
| | | lez | for | Lezghian |
| ln | or | lin | for | Lingala |
| lt | or | lit | for | Lithuania (Lithuanian) |
| | | nds | for | Low German |
| | | nds | for | Low Saxon |
| | | loz | for | Lozi |
| | | lub | for | Luba-Katanga |
| | | lua | for | Luba-Lulua |
| | | lui | for | Luiseno |
| | | lun | for | Lunda |
| | | luo | for | Luo (Kenya and Tanzania) |
| | | lus | for | Lushai |
| mk | or | mac/mke | for | Macedonian |
| | | mad | for | Madurese |
| | | mag | for | Magahi |
| | | mai | for | Maithili |
| | | mak | for | Makasar |
| mg | or | mlg | for | Malagasy |
| ms | or | may/msa | for | Malay |
| ml | or | mal | for | Malayalam |
| mt | or | mlt | for | Maltese |
| | | mdr | for | Mandar |
| | | man | for | Mandingo |
| | | mni | for | Manipuri |
| | | mno | for | Manobo languages |
| | | max | for | Manx |
| mi | or | mao/mri | for | Maori |
| mr | or | mar | for | Marathi |
| | | mah | for | Marshall (Marshallese) |
| | | mwr | for | Marwari |
| | | mas | for | Masai |
| | | myn | for | Mayan languages |
| | | men | for | Mende |
| | | mic | for | Micmac |
| | | min | for | Minangkabau |
| | | i-mingo | for | Mingo |
| | | mis | for | Miscellaneous languages |
| | | moh | for | Mohawk |
| mo | or | mol | for | Moldavian |
| | | mkh | for | Mon-Khmer (Other) |
| | | lol | for | Mongo |
| mn | or | mon | for | Mongolian |
| | | mos | for | Mossi |
| | | mul | for | Multiple languages |
| | | mun | for | Munda languages |
| na | or | nau | for | Nauru |
| | | nav | for | Navajo |
| | | i-navaho | for | Navajo |
| | | nde | for | Ndebele (Zimbabwe) |
| | | nde | for | Ndebele, North |
| | | nbl | for | Ndebele, South |
| | | ndo | for | Ndonga |
| ne | or | nep | for | Nepali |
| | | new | for | Newari |
| | | nai | for | Nias |
| | | nic | for | Niger-Kordofanian (Other) |
| | | ssa | for | Nilo-Saharan (Other) |
| | | niu | for | Niuean |
| | | non | for | Norse, Old |
| | | nai | for | North American Indian (Other) |
| | | sme | for | Northern Sami |
| | | nso | for | Northern Sohto |
| no | or | nor | for | Norwegian |
| | | nob | for | Norwegian Bokmål |
| | | nno | for | Norwegian Nynorsk |
| | | no-bok | for | Norwegian “BookLanugage” |
| | | no-nyn | for | Norwegian “New Norwegian” |
| | | nub | for | Nubian languages |
| | | nym | for | Nyamwezi |
| | | tog | for | Nyasa-Tonga |
| | | nya | for | Nyanja |
| | | nyn | for | Nyankole |
| | | nyo | for | Nyoro |
| | | nzi | for | Nzima |
| oc | or | oci | for | Occitan |
| | | oji | for | Ojibwa |
| | | non | for | Old Norse |
| | | peo | for | Old Persian (ca. 600-400 B.C.) |
| or | or | ori | for | Oriya |
| om | or | gal/orm | for | Oromo |
| | | osa | for | Osage |
| | | oss | for | Ossetic (Ossetian) |
| | | oto | for | Otomian languages |
| | | ota | for | Ottoman-Turkish |
| | | pal | for | Pahlavi |
| | | pau | for | Palauan |
| | | pli | for | Pali |
| | | pam | for | Pampanga |
| | | pag | for | Pangasinan |
| | | pan | for | Panjabi |
| | | pap | for | Papiamento |
| | | paa | for | Papuan-Australian (Other) |
| ps | | | for | Pashto (Pushto) |
| fa | or | per/fas | for | Persian (Farsi) |
| | | peo | for | Persian, Old (ca. 600-400 B.C.) |
| | | phi | for | Philippine (Other) |
| | | phn | for | Phoenician |
| | | pon | for | Pohnpeian |
| pl | or | pol | for | Polish |
| | | pon | for | Ponape |
| pt | or | por | for | Portuguese |
| | | cpp | for | Portuguese-based Creoles and pidgins |
| | | pra | for | Prakrit languages |
| | | oci | for | Provençal |
| | | pro | for | Provencal, Old (to 1500) |
| pa | | | for | Punjabi |
| ps | or | pus | for | Pushto (Pashto) |
| qu | or | que | for | Quechua |
| | | raj | for | Rajasthani |
| | | rap | for | Rapanui |
| | | rar | for | Rarotongan |
| | | qaa-qtz | for | Reserved for local user |
| rm | or | roh | for | Rhaeto-Romance |
| | | roa | for | Romance (Other) |
| ro | or | ron/rum | for | Romanian |
| | | rom | for | Romany |
| | | run | for | Rundi |
| ru | or | rus | for | Russian |
| rw | | | for | Rwanda, Kinya |
| | | ssa | for | Saharan, Nilo-Saharan (Other) |
| | | sal | for | Salishan languages |
| | | sam | for | Samaritan Aramaic |
| | | i-sami-no | for | Sami, North (Norway) |
| | | smi | for | Sami languages (Other) |
| sm | or | sao/smo | for | Samoan |
| | | sad | for | Sandawe |
| sg | or | sag | for | Sangho (Sango) |
| sa | or | san | for | Sanskrit |
| | | sat | for | Santali |
| | | srd | for | Sardinian |
| | | sas | for | Sasak |
| | | nds | for | Saxon, Low |
| | | sco | for | Scots |
| gd | or | gae/gdh | for | Scots Gaelic |
| | | gla | for | Scottish Gaelic |
| | | sel | for | Selkup |
| | | sem | for | Semitic (Other) |
| sr | | | for | Serbian |
| | | scc | for | Serbo-Croatian (Cyrillic) |
| sh | or | scr | for | Serbo-Croatian (Roman) |
| | | srr | for | Serer |
| st | | | for | Sesotho |
| tn | | | for | Setswana |
| | | shn | for | Shan |
| sn | or | sho/sna | for | Shona |
| | | sid | for | Sidamo |
| | | sgn | for | Sign languages |
| | | bla | for | Siksika |
| sd | or | snd | for | Sindhi |
| si | or | sin | for | Singhalese |
| | | snh | for | Sinhalese |
| | | sit | for | Sino-Tibetan (Other) |
| | | sio | for | Siouan languages |
| ss | | | for | Siswati |
| | | den | for | Slave (Athapascan) |
| | | chu | for | Slavic, Church |
| | | sla | for | Slavic (Other) |
| sk | or | slk/slo | for | Slovak |
| sl | or | slv | for | Slovenian |
| | | sog | for | Sogdian |
| so | or | som | for | Somali |
| | | son | for | Songhai |
| | | snk | for | Soninke |
| | | wen | for | Sorbian languages |
| | | nso | for | Sotho, Northern |
| | | sot | for | Sotho, Southern |
| | | sso | for | Sotho |
| | | sai | for | South American Indian (Other) |
| es | or | esl/spa | for | Spanish |
| | | suk | for | Sukuma |
| | | sux | for | Sumerian |
| su | or | sun | for | Sundanese |
| | | sus | for | Susu |
| sw | or | swa | for | Swahili |
| | | ssw | for | Swati |
| | | swz | for | Swazi |
| sv | or | sve/swe | for | Swedish |
| | | syr | for | Syriac |
| tl | or | tag/tgl | for | Tagalog |
| | | tah | for | Tahitian |
| | | tai | for | Tai (Other) |
| | | hai | for | Taiwan (Hakka) |
| | | i-tsu | for | Taiwan (Tsou) |
| tg | or | taj/tgk | for | Tajik |
| | | tmh | for | Tamashek |
| ta | or | tam | for | Tamil |
| tt | or | tar/tat | for | Tatar |
| te | or | tel | for | Telugu |
| | | ter | for | Tereno |
| | | tet | for | Tetum |
| th | or | tha | for | Thai |
| bo | or | bod/tib | for | Tibetan |
| | | sit | for | Tibetan, Sino-Tibetan (Other) |
| | | tig | for | Tigre |
| ti | or | tir | for | Tigrinya |
| | | tem | for | Timne |
| | | tiv | for | Tivi |
| | | tli | for | Tlingit |
| | | tpi | for | Tok Pisin |
| | | tkl | for | Tokelau |
| to | | | for | Tonga |
| | | tog | for | Tonga (Nyasa) |
| | | ton | for | Tonga (Tonga Islands) |
| | | tru | for | Truk |
| | | tsi | for | Tsimshian |
| ts | or | tso | for | Tsonga |
| | | i-tsu | for | Tsou (Taiwan) |
| | | tsw/tsn | for | Tswana |
| | | tum | for | Tumbuka |
| tr | or | tur | for | Turkish |
| | | ota | for | Turkish, Ottoman (1500-1928) |
| tk | or | tuk | for | Turkmen |
| | | tvl | for | Tuvalu |
| | | tyv | for | Tuvinian |
| tw | or | twi | for | Twi |
| | | uga | for | Ugaritic |
| | | uig | for | Uighur |
| ug | | | for | Uigur |
| uk | or | ukr | for | Ukrainian |
| | | umb | for | Umbundu |
| | | und | for | Undetermined |
| ur | or | urd | for | Urdu |
| uz | or | uzb | for | Uzbek |
| | | vai | for | Vai |
| | | ven | for | Venda |
| vi | or | vie | for | Vietnamese |
| vo | or | vol | for | Volapuk (Volapuk) |
| | | vot | for | Votic |
| | | wak | for | Wakashan languages |
| | | wal | for | Walamo |
| | | war | for | Waray |
| | | was | for | Washo |
| cy | or | cym/wel | for | Welsh |
| wo | or | wol | for | Wolof |
| xh | or | xho | for | Xhosa |
| | | sah | for | Yakut |
| | | yao | for | Yao |
| | | yap | for | Yap (Yapese) |
| yi | or | yid | for | Yiddish |
| yo | or | yor | for | Yoruba |
| | | ypk | for | Yupik languages |
| | | znd | for | Zande |
| | | zap | for | Zapotec |
| | | zen | for | Zenaga |
| za | or | zha | for | Zhuang |
| zu | or | zul | for | Zulu |
| | | zun | for | Zuni |

Using the ISO Alpha-2 and Alpha-3 country codes as a way of assigning names to secondary eight bit data character sets, is one possible way of producing the secondary chordic combinations sets for any and all language alphabet scripts or character sets. Entry of the preferred Alpha-2 and Alpha-3 country codes exits the standard eight bit binary chordic data entry method mode, found in this patent application, and enters a secondary eight bit binary chordic data entry method mode set. Languages with extensive alphabet scripts or character sets, like Chinese, requires an eight bit binary data chord followed by an extra secondary eight bit binary data chord. Reassigning the present eight bit binary code invention arrangement, without departing from the spirit and scope of the invention as a whole, produces all language alphabet scripts or character sets.

| | | | | |
|---|---|---|---|---|
| AF | or | AFG | for | Afghanistan |
| AL | or | ALB | for | Albania |
| DZ | or | DZA | for | Algeria |
| AS | or | ASM | for | American Samoa |
| AD | or | AND | for | Andorra |
| AO | or | AGO | for | Angola |
| AI | or | AIA | for | Anguilla |
| AQ | | | for | Antartica |
| AG | or | ATG | for | Antigua and Barbuda |
| AR | or | ARG | for | Argentina |
| AM | or | ARM | for | Armenia |
| AW | or | ABW | for | Aruba |
| AU | or | AUS | for | Australia |
| AT | or | AUT | for | Austria |
| AZ | or | AZE | for | Azerbaijan |
| BS | or | BHS | for | Bahamas |
| BH | or | BHR | for | Bahrain |
| BD | or | BGD | for | Bangladesh |
| BB | or | BRB | for | Barbados |
| BY | or | BLR | for | Belarus |
| BE | or | BEL | for | Belgium |
| BZ | or | BLZ | for | Belize |
| BJ | or | BEN | for | Benin |
| BM | or | BMU | for | Bermuda |
| BT | or | BTN | for | Bhutan |
| BO | or | BOL | for | Bolivia |
| BA | or | BIH | for | Bosnia and Herzegovina |
| BW | or | BWA | for | Botswana |
| BV | | | for | Bouvet Island |
| BR | or | BRA | for | Brazil |
| IO | | | for | British Indian Ocean Territory |
| VG | or | VGB | for | British Virgin Islands |
| BN | or | BRN | for | Brunei Darussalam |
| BG | or | BGR | for | Bulgaria |
| BF | or | BFA | for | Burkina Faso |
| BI | or | BDI | for | Burundi |
| KH | or | KHM | for | Cambodia |
| CM | or | CMR | for | Cameroon |
| CA | or | CAN | for | Canada |
| CV | or | CPV | for | Cape Verde |
| KY | or | CYM | for | Cayman Islands |
| CF | or | CAF | for | Central African Republic |
| TD | or | TCD | for | Chad |
| CL | or | CHL | for | Chile |
| CN | or | CHN | for | China |
| HK | or | HKG | for | HongKong Special Administrative |
| | | MAC | for | Macao Special Administrative Region of China |
| CX | | | for | Christmas Island |
| CC | | | for | Cocos (Keeling) Islands |
| CO | or | COL | for | Colombia |
| KM | or | COM | for | Comoros |
| CG | or | COG | for | Congo |
| CD | or | COD | for | Congo, The Democratic Republic of |
| CK | or | COK | for | Cook Islands |
| CR | or | CRI | for | Costa Rica |
| CI | or | CIV | for | Côte d'Ivoire |
| HR | or | HRV | for | Croatia |
| CU | or | CUB | for | Cuba |
| CY | or | CYP | for | Cyprus |
| CZ | or | CZE | for | Czech Republic |
| KP | or | PRK | for | Democratic People's Republic of Korea |
| CD | or | COD | for | Democratic Republic of the Congo |
| DK | or | DNK | for | Denmark |
| DJ | or | DJI | for | Djibouti |
| DM | or | DMA | for | Dominica |
| DO | or | DOM | for | Dominican Republic |
| TP | or | TMP | for | East Timor |
| EC | or | ECU | for | Ecuador |
| EG | or | EGY | for | Egypt |
| SV | or | SLV | for | El Salvador |
| GQ | or | GNQ | for | Equatorial Guinea |
| ER | or | ERI | for | Eritrea |
| EE | or | EST | for | Estonia |
| ET | or | ETH | for | Ethiopia |
| FO | or | FRO | for | Færoe Islands |
| FK | or | FLK | for | Falkland Islands (Malvinas) |
| FJ | or | FJI | for | Fiji |
| FI | or | FIN | for | Finland |
| FR | or | FRA | for | France |
| GF | or | GUF | for | French Guiana |
| PF | or | PYF | for | French Polynesia |
| TF | | | for | French Southern Territories |
| GA | or | GAB | for | Gabon |
| GM | or | GMB | for | Gambia |
| GE | or | GEO | for | Georgia |
| DE | or | DEU | for | Germany |
| GH | or | GHA | for | Ghana |
| GI | or | GIB | for | Gibraltar |
| GR | or | GRC | for | Greece |
| GL | or | GRL | for | Greenland |
| GD | or | GRD | for | Grenada |
| GP | or | GLP | for | Guadeloupe |
| GU | or | GUM | for | Guam |
| GT | or | GTM | for | Guatemala |
| GN | or | GIN | for | Guinea |
| GW | or | GNB | for | Guinea-Bissau |
| GY | or | GUY | for | Guyana |
| HT | or | HTI | for | Haiti |
| HM | | | for | Heard Island and McDonald Islands |
| VA | or | VAT | for | Holy See (see Vatican City State) |
| HN | or | HND | for | Honduras |
| HK | or | HKG | for | Hong Kong |
| HU | or | HUN | for | Hungary |
| IS | or | ISL | for | Iceland |
| IN | or | IND | for | India |
| ID | or | IDN | for | Indonesia |
| IR | or | IRN | for | Iran (Islamic Republic of) |
| IQ | or | IRQ | for | Iraq |
| IE | or | IRL | for | Ireland |
| IL | or | ISR | for | Israel |
| IT | or | ITA | for | Italy |
| JM | or | JAM | for | Jamaica |
| JP | or | JPN | for | Japan |
| JO | or | JOr | for | Jordan |
| KZ | or | KAZ | for | Kazakhstan |
| KE | or | KEN | for | Kenya |
| KI | or | KIR | for | Kiribati |
| KP | or | PRK | for | Korea, Democratic People's Republic of |
| KR | or | KOr | for | Korea, Republic of |
| KW | or | KWT | for | Kuwait |
| KG | or | KGZ | for | Kyrgyzstan |
| LA | or | LAO | for | Lao People's Democratic Republic |
| LV | or | LVA | for | Latvia |
| LB | or | LBN | for | Lebanon |
| LS | or | LSO | for | Lesotho |
| LR | or | LBR | for | Liberia |
| LY | or | LBY | for | Libyan Arab Jamahiriya |
| LI | or | LIE | for | Liechtenstein |
| LT | or | LTU | for | Lithuania |
| LU | or | LUX | for | Luxembourg |
| MO | | | for | Macau |
| MK | or | MKD | for | Macedonia, The former Yugoslav Republic of |
| MG | or | MDG | for | Madagascar |
| MW | or | MWI | for | Malawi |
| MY | or | MYS | for | Malaysia |
| MV | or | MDV | for | Maldives |
| ML | or | MLI | for | Mali |
| MT | or | MLT | for | Malta |
| MH | or | MHL | for | Marshall Islands |
| MQ | or | MTQ | for | Martinique |
| MR | or | MRT | for | Mauritania |
| MU | or | MUS | for | Mauritius |
| YT | | | for | Mayotte |
| MX | or | MEX | for | Mexico |
| FM | or | FSM | for | Micronesia, Federated States of |
| MD | or | MDA | for | Moldova, Republic of |
| MC | or | MCO | for | Monaco |
| MN | or | MNG | for | Mongolia |
| MS | or | MSR | for | Montserrat |
| MA | or | MAR | for | Morocco |
| MZ | or | MOZ | for | Mozambique |
| MM | or | MMR | for | Myanmar |
| NA | or | NAM | for | Namibia |
| NR | or | NRU | for | Nauru |
| NP | or | NPL | for | Nepal |
| NL | or | NLD | for | Netherlands |
| AN | or | ANT | for | Netherlands Antilles |
| NC | or | NCL | for | New Caledonia |
| NZ | or | NZL | for | New Zealand |
| NI | or | NIC | for | Nicaragua |
| NE | or | NER | for | Niger |
| NG | or | NGA | for | Nigeria |
| NU | or | NIU | for | Niue |
| NF | or | NFK | for | Norfolk Island |
| MP | or | MNP | for | Northern Mariana Islands |
| NO | or | NOr | for | Norway |
| OM | or | OMN | for | Oman |
| PK | or | PAK | for | Pakistan |
| PW | or | PLW | for | Palau |
| PS | or | PSE | for | Palestinian Occupied Territory |
| PA | or | PAN | for | Panama |
| PG | or | PNG | for | Papua New Guinea |
| PY | or | PRY | for | Paraguay |
| PE | or | PER | for | Peru |
| PH | or | PHL | for | Philippines |
| PN | or | PCN | for | Pitcairn |
| PL | or | POL | for | Poland |
| PT | or | PRT | for | Portugal |
| PR | or | PRI | for | Puerto Rico |
| QA | or | QAT | for | Qatar |
| KR | or | KOr | for | Republic of Korea |
| MD | or | MDA | for | Republic of Moldova |
| RE | or | REU | for | Réunion |
| RO | or | ROM | for | Romania |
| RU | or | RUS | for | Russian Federation |
| RW | or | RWA | for | Rwanda |
| SH | or | SHN | for | Saint Helena |
| KN | or | KNA | for | Saint Kitts and Nevis |
| LC | or | LCA | for | Saint Lucia |
| PM | or | SPM | for | Saint Pierre and Miquelon |
| VC | or | VCT | for | Saint Vincent and the Grenadines |
| WS | or | WSM | for | Samoa |
| SM | or | SMR | for | San Marino |
| ST | or | STP | for | Sao Tome and Principe |
| SA | or | SAU | for | Saudi Arabia |
| SN | or | SEN | for | Senegal |
| SC | or | SYC | for | Seychelles |
| SL | or | SLE | for | Sierra Leone |
| SG | or | SGP | for | Singapore |
| SK | or | SVK | for | Slovakia |
| SI | or | SVN | for | Slovenia |
| SB | or | SLB | for | Solomon Islands |
| SO | or | SOM | for | Somalia |
| ZA | or | ZAF | for | South Africa |
| GS | | | for | South Georgia & the South Sandwich Islands |
| ES | or | ESP | for | Spain |
| LK | or | LKA | for | Sri Lanka |
| SD | or | SDN | for | Sudan |
| SR | or | SUR | for | Suriname |
| SJ | or | SJM | for | Svalbard and Jan Mayen Islands |
| SZ | or | SWZ | for | Swaziland |
| SE | or | SWE | for | Sweden |
| CH | or | CHE | for | Switzerland |
| SY | or | SYR | for | Syrian Arab Republic |
| TW | or | TWN | for | Taiwan, Province of China |
| TJ | or | TJK | for | Tajikistan |
| TZ | or | TZA | for | Tanzania, United Republic of |
| TH | or | THA | for | Thailand |
| MK | or | MKD | for | The former Yugoslav Republic of Macedonia |
| TG | or | TGO | for | Togo |
| TK | or | TKL | for | Tokelau |
| TO | or | TON | for | Tonga |
| TT | or | TTO | for | Trinidad and Tobago |
| TN | or | TUN | for | Tunisia |
| TR | or | TUR | for | Turkey |
| TM | or | TKM | for | Turkmenistan |
| TC | or | TCA | for | Turks and Caicos Islands |
| TV | or | TUV | for | Tuvalu |
| UG | or | UGA | for | Uganda |
| UA | or | UKR | for | Ukraine |
| AE | or | ARE | for | United Arab Emirates |
| GB | or | GBR | for | United Kingdom |
| TZ | or | TZA | for | United Republic of Tanzania |
| US | or | USA | for | United States |
| UM | | | for | United States Minor Outlying Islands |
| VI | or | VIR | for | United States Virgin Islands |
| UY | or | URY | for | Uruguay |
| UZ | or | UZB | for | Uzbekistan |
| VU | or | VUT | for | Vanuatu |
| VA | or | VAT | for | Vatican City State (see Holy See) |
| VE | or | VEN | for | Venezuela |
| VN | or | VNM | for | Viet Nam |
| VG | or | VGB | for | Virgin Islands, British |
| VI | or | VIR | for | Virgin Islands, U.S. |
| WF | or | WLF | for | Wallis and Futuna Islands |
| EH | or | ESH | for | Western Sahara |
| YE | or | YEM | for | Yemen |
| YU | or | YUG | for | Yugoslavia |
| CG | or | COG | for | Zaire (The Democratic Republic of Congo) |
| ZM | or | ZMB | for | Zambia |
| ZW | or | ZWE | for | Zimbabwe |

Using the country's area code as a way of assigning names to secondary eight bit data character sets, is one possible way of producing the secondary chordic combinations sets for any and all language alphabet scripts or character sets. Entry of the preferred country area codes exits the standard eight bit binary chordic data entry method mode, found in this patent application, and enters a secondary eight bit binary chordic data entry method mode set. Languages with extensive alphabet scripts or character sets, like Chinese, requires an eight bit binary data chord followed by an extra secondary eight bit binary data chord. Reassigning the present eight bit binary code invention arrangement, without departing from the spirit and scope of the invention as a whole, produces all language alphabet scripts or character sets.

| | | |
|---|---|---|
| 93 | for | Afghanistan |
| 355 | for | Albania |
| 213 | for | Algeria |
| 684 | for | American Samoa |
| 376 | for | Andorra |
| 244 | for | Angola |
| 54 | for | Argentina |
| 374 | for | Armenia |
| 297 | for | Aruba |
| 247 | for | Ascension |
| 61 | for | Australia |
| 672 | for | Australian Ext. Terr. |
| 43 | for | Austria |
| 994 | for | Azerbaijan |
| 973 | for | Bahrain |
| 880 | for | Bangladesh |
| 375 | for | Belarus |
| 32 | for | Belgium |
| 501 | for | Belize |
| 229 | for | Benin |
| 975 | for | Bhutan |
| 591 | for | Bolivia |
| 387 | for | Bosnia - Herzegovina |
| 267 | for | Botswana |
| 55 | for | Brazil |
| 673 | for | Brunei Darussalam |
| 359 | for | Bulgaria |
| 226 | for | Burkina Faso |
| 257 | for | Burundi |
| 855 | for | Cambodia |
| 237 | for | Cameroon |
| 238 | for | Cape Verde |
| 236 | for | Central African Rep. |
| 235 | for | Chad |
| 56 | for | Chile |
| 86 | for | China (People's Rep.) |
| 57 | for | Colombia |
| 269 | for | Comoros Is. |
| 242 | for | Congo |
| 682 | for | Cook Islands |
| 506 | for | Costa Rica |
| 385 | for | Croatia |
| 53 | for | Cuba |
| 357 | for | Cyprus |
| 420 | for | Czech Republic |
| 45 | for | Denmark |
| 246 | for | Diego Garcia |
| 253 | for | Djibouti |
| 670 | for | East Timor |
| 593 | for | Ecuador |
| 20 | for | Egypt |
| 503 | for | El Salvador |
| 291 | for | Eritrea |
| 372 | for | Estonia |
| 251 | for | Ethiopia |
| 240 | for | Equatorial Guinea |
| 691 | for | F.S. Micronesia |
| 298 | for | Færoe Islands |
| 500 | for | Falkland Islands |
| 679 | for | Fiji |
| 358 | for | Finland |
| 33 | for | France |
| 689 | for | French Polynesia |
| 241 | for | Gabon |
| 220 | for | Gambia |
| 995 | for | Georgia (Republic of) |
| 49 | for | Germany |
| 233 | for | Ghana |
| 350 | for | Gibraltar |
| 30 | for | Greece |
| 299 | for | Greenland |
| 590 | for | Guadeloupe |
| 502 | for | Guatemala |
| 594 | for | Guiana (French) |
| 224 | for | Guinea |
| 245 | for | Guinea-Bissau |
| 592 | for | Guyana |
| 509 | for | Haiti |
| 504 | for | Honduras |
| 852 | for | Hong Kong |
| 36 | for | Hungary |
| 354 | for | Iceland |
| 91 | for | India |
| 62 | for | Indonesia |
| 98 | for | Iran |
| 964 | for | Iraq |
| 353 | for | Ireland |
| 972 | for | Israel |
| 39 | for | Italy |
| 225 | for | Ivory Coast |
| 81 | for | Japan |
| 962 | for | Jordan |
| 997 | for | Kazakhstan |
| 254 | for | Kenya |
| 686 | for | Kiribati |
| 850 | for | Korea (North) |
| 82 | for | Korea (South) |
| 965 | for | Kuwait |
| 996 | for | Kyrgyz Republic |
| 856 | for | Laos |
| 371 | for | Latvia |
| 961 | for | Lebanon |
| 266 | for | Lesotho |
| 231 | for | Liberia |
| 218 | for | Libya |
| 423 | for | Liechtenstein |
| 370 | for | Lithuania |
| 352 | for | Luxembourg |
| 853 | for | Macau |
| 389 | for | Macedonia (FYR) |
| 261 | for | Madagascar |
| 265 | for | Malawi |
| 60 | for | Malaysia |
| 960 | for | Maldives |
| 223 | for | Mali |
| 356 | for | Malta |
| 692 | for | Marshall Islands |
| 596 | for | Martinique |
| 222 | for | Mauritania |
| 230 | for | Mauritius |
| 269 | for | Mayotte ( Comoros Is. ) |
| 52 | for | Mexico |
| 691 | for | Micronesia |
| 373 | for | Moldova |
| 377 | for | Monaco |
| 976 | for | Mongolia |
| 212 | for | Morocco |
| 258 | for | Mozambique |
| 95 | for | Myanmar (Burma) |
| 264 | for | Namibia |
| 674 | for | Nauru |
| 977 | for | Nepal |
| 31 | for | Netherlands |
| 599 | for | Netherlands Antilles |
| 687 | for | New Caledonia |
| 64 | for | New Zealand |
| 505 | for | Nicaragua |
| 227 | for | Niger |
| 234 | for | Nigeria |
| 683 | for | Niue |
| 1 | for | North America |
| 47 | for | Norway |
| 968 | for | Oman |
| 92 | for | Pakistan |
| 680 | for | Palau |
| 970 | for | Palestine |
| 507 | for | Panama |
| 675 | for | Papua New Guinea |
| 595 | for | Paraguay |
| 51 | for | Peru |
| 63 | for | Philippines |
| 48 | for | Poland |
| 351 | for | Portugal |
| 974 | for | Qatar |
| 262 | for | Reunion Island |
| 40 | for | Romania |
| 7 | for | Russia (Kazakhstan) |
| 250 | for | Rwanda |
| 290 | for | Saint Helena |
| 378 | for | San Marino |
| 239 | for | São Tomé & Principé |
| 881 | for | Satellite services |
| 966 | for | Saudi Arabia |
| 221 | for | Senegal |
| 248 | for | Seychelles |
| 232 | for | Sierra Leone |
| 65 | for | Singapore |
| 421 | for | Slovakia |
| 386 | for | Slovenia |
| 677 | for | Solomon Islands |
| 252 | for | Somalia |
| 27 | for | South Africa |
| 34 | for | Spain |
| 94 | for | Sri Lanka |
| 508 | for | St. Pierre & Miquélon |
| 249 | for | Sudan |
| 597 | for | Suriname |
| 268 | for | Swaziland |
| 46 | for | Sweden |
| 41 | for | Switzerland (Liecht.) |
| 963 | for | Syria |
| 886 | for | Taiwan (reserved) |
| 992 | for | Tajikistan |
| 255 | for | Tanzania |
| 66 | for | Thailand |
| 228 | for | Togo |
| 690 | for | Tokelau |
| 676 | for | Tonga |
| 216 | for | Tunisia |
| 90 | for | Turkey |
| 993 | for | Turkmenistan |
| 688 | for | Tuvalu |
| 256 | for | Uganda |
| 380 | for | Ukraine |
| 851 | for | unassigned |
| 971 | for | United Arab Emirates |
| 44 | for | United Kingdom |
| 998 | for | Uzbekistan |
| 678 | for | Vanuatu |
| 379 | for | Vatican City |
| 58 | for | Venezuela |
| 84 | for | Viet Nam |
| 681 | for | Wallis and Futuna |
| 685 | for | Western Samoa |
| 967 | for | Yemen |
| 381 | for | Yugoslavia |
| 243 | for | Zaire |
| 260 | for | Zambia |
| 263 | for | Zimbabwe |

It is possible to choose a variety of scripts and data entry choices such as Latin based language alphabets, multinational languages, any and all foreign languages with less than 65,025 (255×255) characters in the language, font set, monetary symbols set, phonetic symbols set, typographic symbols set, iconic symbols set, math symbols set, scientific symbols set, box drawing symbols set, graphics, macros, etc. Exiting a mode or any modes can be achieved by using the “shift out” (#175) function.

The eight bit binary code can also be used as a finger braille type of communication by the deaf-blind, where the transmitter transmits (Finger Braille) the mirror imaged binary data chord from the left hand onto the right hand and the mirror imaged binary data chord from the right hand onto the mirror imaged left hand, so the receiver receives (Fingers) the binary data in its preferred embodiment. This physiological aspect of this method is that the transmitter already knows what they are going to transmit, so they simply switch the four digit binary chords on either hand so that the receiver has more time to easily process the binary data into words and other types of communication. If an individual is missing a thumb digit, the system can be implemented by using the index, middle, ring and little (pinkie) digit of the left and right hands. When used as a form of binary braille finger spelling for the deaf-blind, two individuals face each other, and place their hands in the following touching arrangement: transmitters left hand to receivers right hand and transmitters right hand to receivers left hand, thumb to thumb, digit to digit, etc. When transmitting data, the transmitter transmits binary hand chords from the preferred left hand group to the right hand group and from the preferred At right hand group to the left hand group. For example, when transmitting the lower-case letter “b” (#40) chord (0001 0100), the transmitter transmits the mirror image binary chord for the upper-case vowel “E” (#20) (0010 1000). The receiver will then receive the lower case letter “b”. The technique for producing vowel and consonant chords to communicate to a deaf-blind individual is explained in the Finger Braille tables found in FIGS. 1A-1P. An easier to learn arrangement is explained in the Finger Braille tables found in FIGS. 3A-3L.

The system and method of the invention is logically developed and implemented so that it is easy to learn and quick to use, especially for those who are handicapped or sight impaired.

These and other features of the present invention will be more fully understood by referencing the drawings.

The system and method can use a variety of different keyboards, including some that are already on the market. For example, the split space bar QWERTY keyboard needs only to be reprogrammed. Additional instructions can be entered by the keyboard system and method according to the preferred embodiment which are consistent with instructions that also can be produced with the QWERTY keyboard, Dvorak keyboard, or other types of Latin based alphabet foreign language keyboards such as the Spanish, French, German, Italian, Swedish/Finnish, Canadian bilingual along with many other types of Latin based alphabet keyboards known to those of ordinary skill in the art, as long as they have as split space bar or a way of using at least eight keys or sensors to enter data. Other known keyboards and data entry devices can also be employed for the same purpose of entering information into a word processor or computer, such as typewriters, braille writers, word processors, phones, computers systems, laptops, keyboards, touch screen input devices, PDAs, cell phones, virtual keyboards and the like.

The most convenient way to employ the improved keyboard system is to provide an interface or software which translates the eight digit binary code into a standard computer code such as ASCII, extended ASCII or EBCDIC, which a conventional computer will be able to recognize. This can be done external to the computer through a hardwired interface, internal to the computer through an electronic interpreter or through a software program using the translation instructions found in FIGS. 1A-1P using source code programming techniques that are very well known to those of ordinary skill in the art.

In summary, the virtual keyboard invention, using an eight bit binary code data entry system and method, according to the preferred embodiment and alternative embodiments of the invention, is relatively easy to learn and very easy to use, especially by handicapped and visualy impaired individuals. The vowels, consonants, numbers, etc. are produced in a unique and logical way that makes them easy to learn and remember, and also quick to implement. Other features and functions of the invention achieve the same result.

While the invention has been described with reference to the preferred embodiment thereof, it will be appreciated by those of ordinary skill in the art that various modifications can be made to the system and method of the invention without departing from the spirit and scope of the invention as a whole.

A portion of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

I claim:

1. An eight bit code read from left to right on at least eight sensors comprising:
a first four bit code combined with a second four bit code to produce data.

2. An eight bit code read from left to right on at least eight sensors to produce data, in accordance with claim 1, wherein:
a) a left first bit of said eight bit code has the numeric value of one, and
b) a second bit of said eight bit code has the numeric value of two, and
c) a third bit of said eight bit code has the numeric value of four, and
d) a fourth bit of said eight bit code has the numeric value of eight, and
e) a fifth bit of said eight bit code has the numeric value of sixteen, and
f) a sixth bit of said eight bit code has the numeric value of thirty-two, and
g) a seventh bit of said eight bit code has the numeric value of sixty-four, and
h) a right eighth bit of said eight bit code has the numeric value of one hundred and twenty-eight.

3. A method of producing data using an eight bit code read from left to right on at least eight sensors comprising the step of:
activating at least one sensor to enter an eight sensor data entry mode.

4. A method of producing data using an eight bit code read from left to right on at least eight sensors, in accordance with claim 3, comprising the step of:
activating at least one said sensor of said eight sensors to enter an eight sensor data entry mode.

5. A method of producing data using an eight bit code read from left to right on at least eight sensors, in accordance with claim 3, comprising the step of:
activating all said eight sensors to enter an eight sensor data entry mode.

6. A method of producing data using an eight bit code read from left to right on at least eight sensors, in accordance with claim 3, comprising the step of:
activating at least one said sensor of said eight sensors to produce a data character.

7. A method of producing data using an eight bit code read from left to right on at least eight sensors, in accordance with claim 3, comprising the step of:
activating at least one said sensor of said eight sensors to produce a function.

8. A method of producing data using an eight bit code read from left to right on at least eight sensors, in accordance with claim 3, comprising the step of:
activating at least one said sensor of said eight sensors to produce a data character string.

9. A method of using a first four bit code combined with a second four bit code on at least eight sensors, in accordance with claim 3, comprising the step of:
activating at least one said sensor of said eight sensors followed by the activating of at least one said sensor of said eight sensors to produce a data character.

10. A method of using a first four bit code combined with a second four bit code on at least eight sensors, in accordance with claim 3, comprising the step of:
activating at least one said sensor of said eight sensors followed by the activating of at least one said sensor of said eight sensors to produce a data character string.

11. A method of using a first four bit code combined with a second four bit code on at least eight sensors, in accordance with claim 3, comprising the step of:
activating at least one said sensor of a first set of four sensors combined with non-activating a second set of four sensors to produce a vowel.

12. A method of using a first four bit code combined with a second four bit code on at least eight sensors, in accordance with claim 3, comprising the step of:
activating at least one said sensor of a first set of four sensors combined with the activating of at least one said sensor of a second set of four sensors to produce a vowel.

13. A method of using a first four bit code combined with a second four bit code on at least eight sensors, in accordance with claim 3, comprising the step of:
activating at least one said sensor of a first set of four sensors combined with the activating of at least one said sensor of a second set of four sensors to produce a consonant.

14. A method of using a first four bit code combined with a second four bit code on at least eight sensors, in accordance with claim 3, comprising the step of:
non-activating a first set of four sensors combined with the activating of at least one said sensor of a second set of four sensors to produce a space.

15. A method of using a first four bit code combined with a second four bit code on at least eight sensors, in accordance with claim 3, comprising the step of:
non-activating a first set of four sensors combined with the activating of at least one said sensor of a second set of four sensors to produce a punctuation mark.

16. A method of using a first four bit code combined with a second four bit code on at least eight sensors, in accordance with claim 3, comprising the step of:
activating at least one said sensor of a first set of four sensors combined with the activating of at least one said sensor of a second set of four sensors to produce a symbol.

17. A method of using a first four bit code combined with a second four bit code on at least eight sensors, in accordance with claim 3, comprising the step of:
activating at least one said sensor of a first set of four sensors combined with the activating of all said sensors of a second set of four sensors to produce a number.

18. A method of using a first four bit code combined with a second four bit code on at least eight sensors, in accordance with claim 3, comprising the step of:
activating at least one said sensor of a first set of four sensors combined with the activating of all but one sensor of a second set of four sensors to produce a function.

19. An apparatus for entering an eight bit code read from left to right on at least eight sensors wherein:
a) a first left bit has the numeric value of one and is a left digit sensor, and
b) a second bit has the numeric value of two and is a left digit sensor, and
c) a third bit has the numeric value of four and is a left digit sensor, and
d) a fourth bit has the numeric value of eight and is a left digit sensor, and
e) a fifth bit has the numeric value of sixteen and is a right digit sensor, and
f) a sixth bit has the numeric value of thirty-two and is a right digit sensor, and
g) a seventh bit has the numeric value of sixty-four and is a right digit sensor, and
h) a eighth right bit has the numeric value of one hundred and twenty-eight and is a right digit sensor.

20. A method of entering an eight bit code read from left to right on at least eight sensors comprising the step of:
a) activating one said left digit sensor moves an object in a first direction, and
b) activating one said right digit sensor moves said object in a second opposite direction.

21. A method of entering an eight bit code read from left to right on at least eight sensors, in accordance with claim 20, comprising the step of:
a) activating one said left digit sensor moves an object to the left, and
b) activating one said right digit sensor moves said object to the right.

22. A method of entering an eight bit code read from left to right on at least eight sensors, in accordance with claim 20, comprising the step of:
a) activating one said left digit sensor rotates an object to the left, and
b) activating one said right digit sensor rotates said object to the right.

23. A method of entering an eight bit code read from left to right on at least eight sensors, in accordance with claim 20, comprising the step of:
a) activating one said left digit sensor moves an object backward, and
b) activating one said right digit sensor moves said object forward.

24. A method of entering an eight bit code read from left to right on at least eight sensors, in accordance with claim 20, comprising the step of:
a) activating one said left digit sensor moves an object down, and
b) activating one said right digit sensor moves said object up.

25. A method of entering an eight bit code read from left to right on at least eight sensors, in accordance with claim 20, comprising the step of:
activating one said left digit sensor and one said right digit sensor simultaneously moves an object forward.

26. A method of entering an eight bit code read from left to right on at least eight sensors, in accordance with claim 20, comprising the step of:
activating one said left digit sensor and one said right digit sensor simultaneously followed by activating one said left digit sensor and one said right digit sensor simultaneously moves an object backward.

27. An apparatus for entering an eight bit code read from left to right on at least eight sensors, in accordance with claim 19, wherein:
a) a first left bit has the numeric value of one and is a left digit sensor, and
b) a second bit has the numeric value of two and is a left digit sensor, and
c) a third bit has the numeric value of four and is a left digit sensor, and
d) a fourth bit has the numeric value of eight and is a left thumb sensor, and
e) a fifth bit has the numeric value of sixteen and is a right thumb sensor, and
f) a sixth bit has the numeric value of thirty-two and is a right digit sensor, and
g) a seventh bit has the numeric value of sixty-four and is a right digit sensor, and
h) a eighth right bit has the numeric value of one hundred and twenty-eight and is a right digit sensor.

28. A method of entering an eight bit code read from left to right on at least eight sensors, in accordance with claim 20, comprising the step of:
a) activating a left thumb sensor moves the cursor to the left, and
b) activating a right thumb sensor moves said cursor to the right.

29. A method of entering an eight bit code read from left to right on at least eight sensors, in accordance with claim 20, comprising the step of:
a) activating a left thumb sensor deletes data to the left of the cursor, and
b) activating a right thumb sensor deletes data to the right of said cursor.

30. A method of entering an eight bit code read from left to right on at least eight sensors, in accordance with claim 20, comprising the step of:
a) activating a left thumb sensor reverses the last change, and
b) activating a right thumb sensor reverses the last undo.

31. A method of entering an eight bit code read from left to right on at least eight sensors, in accordance with claim 20, comprising the step of:
a) activating a left thumb sensor and a right thumb sensor simultaneously exits said first data entry mode and enters a cursor movement mode, and
b) activating said left thumb sensor moves the cursor to the left and activating said right thumb sensor moves said cursor to the right; and
c) activating said left thumb sensor and said right thumb sensor simultaneously exits said cursor movement mode and enters a delete mode, and
d) activating said left thumb sensor deletes data to the left of said cursor and activating said right thumb sensor deletes data to the right of said cursor, and
e) activating said left thumb sensor and said right thumb sensor simultaneously exits said delete mode and re-enters said first data entry mode.

32. A method of producing data using at least eight sensors comprising the step of:
shifting into a second mode by entering at least one data character.

33. A method of producing data using at least eight sensors, in accordance with claim 32, comprising the step of:
shifting into a second mode by entering the language code data character string.

34. A method of producing data using at least eight sensors, in accordance with claim 32, comprising the step of:
shifting into a second mode by entering the country code data character string.

35. A method of producing data using at least eight sensors, in accordance with claim 32, comprising the step of:
shifting into a second mode by entering the country's area code data character string.
